(19) United States
(12) Patent Application Publication
(10) Pub. No.: US 2026/0360186 A1
(43) Pub. Date: Nov. 12, 2026

(54) DETECTING IMAGE MATCHES AND ACTIONS USING COMPUTER VIDEO AND IMAGE PROCESSING

(71) Applicant: Target Brands, Inc., Minneapolis, MN (US)

(72) Inventors: Arun Patil, Bengaluru (IN); Nirmal Kumar, Bengaluru (IN); Evan Gaustad, Minneapolis, MN (US); Keerthana B, Bengaluru (IN); Yashwantha BN, Bengaluru (IN); Ragavendran MV, Bengaluru (IN); Vidya Hungud, Bengaluru (IN)

(73) Assignee: Target Brands, Inc., Minneapolis, MN (US)

(21) Appl. No.: 19/202,797

(22) Filed: May 8, 2025

(51) Int. Cl. G06V 40/20; G06T 7/246; G06V 10/75; G06V 20/40; G06V 40/10

(52) U.S. Cl. CPC G06V 40/23; G06T 7/248; G06V 10/751; G06V 20/41; G06V 20/49; G06V 40/10

(57) ABSTRACT

Aspects of the present disclosure relate to a person reidentification system and an action detection system. Each of the systems may be communicatively coupled with a video processing platform that collects video and image data from a location. The person reidentification system may analyze data from the video processing platform to match a first one or more images of a person at a first location with a second one or more images of the person at a second location. The action detection platform may detect actions in video segments by, for example, comparing embeddings associated with video segments and embeddings associated with actions. In some embodiments, each of the person reidentification system and the action detection system may be communicatively coupled with a dashboard that can receive and display data.

### BACKGROUND

Computer processing of images and videos may be helpful in various contexts, such as detecting people and actions. However, there may be numerous challenges. For example, a video monitoring system may generate large quantities of data. Efficiently managing and processing these large volumes of data may be challenging. Additionally, varying lighting conditions, occlusions, motion blur, varying quality across images, camera differences, and other factors may complicate the task of accurately detecting and recognizing objects or actions. Moreover, it is necessary to safeguard the privacy of individuals whose images may be captured by cameras that are part of a video monitoring system. Image and video processing techniques must account for these challenges without significant loss in performance.

### SUMMARY

Aspects of the present disclosure relate to a person reidentification system and an action detection system. Each of the systems may be communicatively coupled with a video processing platform that collects video and image data from a location. The person reidentification system may analyze data from the video processing platform to match a first one or more images of a person at a first location with a second one or more images of the person at a second location. The action detection platform may detect actions in video segments by, for example, comparing embeddings associated with video segments and embeddings associated with actions. In some embodiments, each of the person reidentification system and the action detection system may be communicatively coupled with a dashboard that can receive and display data.

In a first aspect, a system for performing person reidentification is disclosed. The system comprises a video processing platform including a first at least one processor and a first memory storing first instructions; a person reidentification platform communicatively coupled with the video processing platform, the person reidentification platform including a second at least one processor and a second memory storing second instructions; wherein the first instructions, when executed by the first at least one processor, cause the video processing platform to: receive a plurality of video frames captured by a first camera at a first location; from the plurality of video frames, select an image of a person; and provide the image of the person to the person reidentification platform; wherein the second instructions, when executed by the second at least one processor, cause the person reidentification platform to: receive the image of the person from the video processing platform; receive, from a second video processing platform, a plurality of candidate images captured by a second camera at a second location, the second location being located within a range from the first location; generate a first feature vector for the image of the person; generate a plurality of second feature vectors for the plurality of candidate images; and compare the first feature vector to the plurality of second feature vectors to determine, from the plurality of candidate images, a similar image to the image of the person.

In a second aspect, a method for reidentifying a person across locations is disclosed. The method comprises receiving, at a video processing platform, a plurality of video frames captured by a first camera at a first location; from the plurality of video frames, selecting, at the video processing platform, an image of a person; and providing, from the video processing platform, the image of the person to a person reidentification platform; receiving, at the person reidentification platform, the image of the person from the video processing platform; at the person reidentification platform, receiving, from a second video processing platform, a plurality of candidate images captured by a second camera at a second location, the second location being located within a range from the first location; generating, at the person reidentification platform, a first feature vector for the image of the person; generating, at the person reidentification platform, a plurality of second feature vectors for the plurality of candidate images; comparing, at the person reidentification platform, the first feature vector to the plurality of second feature vectors to determine, from the plurality of candidate images, a similar image to the image of the person; and identifying, at the video processing platform, the person in the similar image.

In a third aspect, a person reidentification platform is disclosed. The platform comprises at least one processor; and memory storing instructions, wherein the instructions, when executed by the at least one processor, cause the person reidentification platform to: receive, from a video processing platform, a plurality of images of a person, the plurality of images of the person being selected by the video processing platform from a plurality of video frames captured by a first camera at a first location; receive, from a second video processing platform, a plurality of candidate images captured by a second camera at a second location, the second location being located within a range from the first location; generate a first plurality of feature vectors for the plurality of images of the person; generate a second plurality of feature vectors for the plurality of candidate images; and compare the first plurality of feature vectors to the second plurality of feature vectors to determine, from the plurality of candidate images, a plurality of similar images to the plurality of images of the person.

In a fourth aspect, a system for detecting actions in video is disclosed. The system comprises a video processing platform including a first at least one processor and a first memory storing first instructions; and an action detection platform communicatively coupled with the video processing platform, the action detection platform including a second at least one processor and a second memory storing second instructions; wherein the first instructions, when executed by the first at least one processor, cause the video processing platform to: obtain video data captured by a camera at a location; filter the video data to a subset of the video data; and provide the subset of the video data to the action detection platform; wherein the second instructions, when executed by the second at least one processor, cause the action detection platform to: receive the subset of the video data; chunk the subset of the video data into a plurality of video segments; apply a multi-modal machine learning model to the plurality of video segments to generate a plurality of embeddings for the plurality of video segments; perform a comparison of a first embedding of the plurality of embeddings for the plurality of video segments and a second embedding corresponding to an action; and based on the comparison, determine that a video segment corresponding to the first embedding includes the action.

In a fifth aspect, a method for detecting actions in video is disclosed. The method comprises obtaining, at a video processing platform, video data captured by a camera at a location; filtering, at the video processing platform, the video data to a subset of the video data; providing, from the video processing platform, the subset of the video data to an action detection platform; receiving, at the action detection platform, the subset of the video data; chunking, at the action detection platform, the subset of the video data into a plurality of video segments; applying a multi-modal machine learning model to the plurality of video segments to generate a plurality of embeddings for the plurality of video segments; performing, at the action detection platform, a comparison of a first embedding of the plurality of embeddings for the plurality of video segments and a second embedding corresponding to an action; and based on the comparison, determining, at the action detection platform, that a video segment corresponding to the first embedding includes the action.

In a sixth aspect, an action detection platform is disclosed. The platform comprises at least one processor; and memory storing instructions, wherein the instructions, when executed by the at least one processor, cause the action detection platform to: receive, from a video processing platform, a subset of video data, the subset of video data being filtered from video data captured by a camera at a location; chunk the subset of the video data into a plurality of video segments; apply a multi-modal machine learning model to the plurality of video segments to generate a plurality of embeddings for the plurality of video segments; perform a comparison of a first embedding of the plurality of embeddings for the plurality of video segments and a second embedding corresponding to an action; and based on the comparison, determine that a video segment corresponding to the first embedding includes the action.

### BRIEF DESCRIPTION OF THE DRAWINGS

FIG. 1 illustrates an example network environment in which aspects of the present disclosure may be implemented.

FIG. 2 illustrates a schematic diagram of an example architecture of a video processing platform.

FIG. 3 illustrates a schematic diagram of an example architecture of a person reidentification platform.

FIG. 4 is a flowchart of an example method according to aspects of the present disclosure.

FIG. 5 is a flowchart of an example method according to aspects of the present disclosure.

FIG. 6 is a flowchart of an example method according to aspects of the present disclosure.

FIG. 7 illustrates an example table depicting data that may be generated by aspects of the present disclosure.

FIG. 8 illustrates a schematic diagram of an example architecture of an action detection platform.

FIG. 9 is a flowchart of an example method according to aspects of the present disclosure.

FIG. 10 is a flowchart of an example method according to aspects of the present disclosure.

FIG. 11 is a flowchart of an example method according to aspects of the present disclosure.

FIG. 12 illustrates an example diagram depicting data that may be generated by aspects of the present disclosure.

FIG. 13 is a flowchart of an example method according to aspects of the present disclosure.

FIG. 14 is a flowchart of an example method according to aspects of the present disclosure.

FIG. 15 illustrates an example user interface of a dashboard.

FIG. 16 illustrates an example user interface of a dashboard.

FIG. 17 illustrates an example user interface of a dashboard.

FIG. 18 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In example aspects, a system for performing person reidentification is disclosed. The system may identify images of individuals that visit multiple locations without determining an identity of that person. For example, the system may not generate or store personally identifying information or biometric information of a person who is reidentified. The system may include various components, including a video processing platform, a reidentification platform that compares images captured at different locations, and a dashboard for browsing results of the reidentification platform.

In example aspects, the video processing platform includes cameras across a location that capture videos of people, such as people or workers. The videos can be separated into images. The video processing platform may include models to detect and track people within images by using image processing techniques, such as bounding boxes, background modeling, and person detection algorithms. For each person, the video processing platform may select an image. In some instances, the video processing platform may, for a person, select a plurality of images, which may be key crops or best images, that may be subsequently used by the reidentification platform to detect the person at different locations.

In example aspects, the selection of the image or the plurality of images of the person may be based on detected facial features of the person, such as the following: face sharpness, face orientation, size, aspect ratio, best side view, or another metric. Additionally, the image or images of the person may be further transformed, such as by rotating, aligning, and segmenting them. Although facial features may be used to select images, these facial features may not be used to match images and are not associated with other identifying information of a person. Advantageously, therefore, a person reidentification task may be performed without storing personally identifying information or sensitive biometric data for a person.

In example aspects, the reidentification platform receives images from video processing platforms across different locations. The reidentification platform may analyze these images to identify when a person visited multiple locations. In general terms, the reidentification platform may include a feature extraction system and an image comparison system, which may be a person reidentification engine. The feature extraction system extracts feature vectors for images. A feature vector may be a machine learning-generated sequence of numbers that encodes information about the image.

For example, the video processing platform may have identified seven images of a person at a location, and the video processing platform may provide the seven images to the person reidentification platform. The feature extraction system of the person reidentification platform may, for each image, apply pre-processing tasks, such as filtering and transforming. The feature extraction system may then provide the images to a machine learning model that processes the images to generate feature vectors, resulting in a feature vector corresponding to each of the images. In some embodiments, the machine learning model may be a pre-trained model for extracting image features.

In example aspects, the image comparison system matches images from different locations, thereby identifying individuals that visited multiple locations, such as physically separate and geographically distanced enterprise locations. To do so, the image comparison system may compare feature vectors of images. In some embodiments, the image comparison system determines nearest neighbors for sets of feature vectors. For a set of feature vectors, which may be derived from images associated with an individual, if the nearest neighbors are features vectors that correspond to images from a particular person at a different location, then the image comparison system may determine that these sets of images correspond to the same person, and that this person visited multiple locations. The multiple locations may correspond to different retail locations of an enterprise, such as different stores.

As an example, a Person A may be at Location X. The video processing platform at Location X may select one or more images of the Person A at Location X, and the feature extraction system determines one or more feature vectors. Next, the reidentification platform may determine a set of nearby locations that Person A may have visited in addition to Location X within a predetermined period of time (e.g., in the same day). To do so, the reidentification platform may identify locations that are sufficiently nearby Location X, such that a person could have visited Location X and the nearby locations. For example, based on the time at which Person A was present at Location X, and based on Location X's geographical location, the system may determine it was possible for Person A to visit Location Y or Location Z, but not Location W, at some time between 6:00 PM and 10:00 PM.

Continuing with the example, the person reidentification platform may retrieve candidate images from Location Y and Z captured from 6:00 PM to 10:00 PM. The person reidentification platform may then compare the images of Person A at Location X to candidate images from Locations Y and Z. For example, for each selected image of Person A at Location X, the most similar candidate image from Location Y are identified based on the distances between the respective feature vectors of the images. The person reidentification platform may then determine if these similar images are associated with a common person, such as Person B at Location Y. If a sufficient number of the similar images are associated with Person B, then the person reidentification platform may determine that there is match, and that Person A at Location X may be identified as the same person as Person B at Location Y. If, however, there are an insufficient number of similar images associated with a particular person at Location Y, then the system may determine that the Person A did not visit Location Y. The person reidentification platform can repeat the process for Location Z, and other stores that Person A may have visited.

In example aspects, the person reidentification platform may also perform backward matching to verify that the reidentification is correct. For example, after comparing images of a person at Location X to candidate images from Location Y, the platform can do the reverse, comparing images of a person at Location Y to candidate images from Location X. By doing so, the person reidentification platform may increase the likelihood that a reidentification is correct.

In example aspects, the person reidentification platform may provide matches, images, and other data to downstream systems. The systems may include a dashboard to explore results from the reidentification platform. The dashboard may be a web application in which an analyst can view reidentifications by store or date. For example, the analyst may view images of all visitors that visited a first and second location on a particular date. The dashboard may also include a toggle for setting a threshold similarity level for a match, where a high threshold causes the system only to display matches for which there is a relatively high level of certainty.

In example aspects, a system for detecting an action in video data is disclosed. The action detection platform may identify an action performed by a person without determining an identify of the person. The action detection platform may not generate or store personally identifying or sensitive biometric data of a person whose actions are identified. The system may include multiple components, including a video processing platform and an action detection platform. The system may use a multi-stage pipeline to detect actions of interest. In some embodiments, the amount of data to analyze at each stage becomes smaller, thereby increasing the efficiency of subsequent stages and narrowing down the video segments to those that are most likely to be indicative of an action of interest.

In example aspects, a camera at a location may capture video data, such as video of a particular area in a store, like a row of items, a self-checkout location, or an exit. The video processing platform may obtain the video data and may filter the video data. Furthermore, the video processing platform may detect motion events, such as a person entering an area of interest. When a motion event is detected, the video processing platform may stream archived or live video data for subsequent processing. Furthermore, the video processing platform may track a person in the video data, thereby capturing multiple video frames that include the person and determining a dwell time of the person in the area of interest.

Continuing with the example, the video processing platform may provide the video data to the action detection platform, which may detect an action of the person in the video data. To do so, the action detection platform may generate an embedding for the video data and compare the embeddings to an embedding that corresponds to the action. In some embodiments, the action detection platform may apply a multi-modal machine learning model to generate an embedding for the video data and to generate an embedding for a text string that describes the action, and a distance between these embeddings in a shared latent space may be determined. Example actions may include picking an item off the shelf or placing an item on the shelf. In some embodiments, for a given video stream, multiple actions may be detected (e.g., it may be detected that a person performed five pick actions).

In example aspects, events may be defined and detected. For example, the conditions for an event may be defined by a human user with the relevant expertise. In the example of item theft, a theft event may be triggered if a person's dwell time is greater than a minute or if the person picks or places at least ten items. Once an event is detected, the action detection platform may provide data corresponding with the event to an event consumer. For example, the action detection platform may provide a video segment to a worker on the premises of the detected event so that the worker can view the video segment and take corrective action if needed.

In example aspects, the action detection platform may be communicatively coupled with a dashboard that may be used to identify actions in videos. For example, the dashboard may receive text searches from a user. The text searches can be for an action, such as “person wearing mask tampering with a lock.” The action detection platform may generate embeddings for the text by using the same machine learning model used to generate video embeddings. The action detection platform may then search the stored video embeddings for the embeddings that are most similar to the text embedding of the text search. Via the dashboard, the action detection platform may then return the video segments associated with the video embeddings that are most similar to the text embeddings of the text search.

In example aspects, when using the dashboard, a user may input different text queries and may set various filters. For example, the user may only search for videos from a particular location or during a particular time period, or for videos in which the dwell time is between X and Y or in which there are at least a threshold number of pre-defined actions. In some embodiments, these filters and text queries can also be used to set conditions to trigger events for downstream review.

In example aspects, features of the person reidentification platform and the action detection platform may be combined. For example, a user of the action detection platform may search for an action (e.g., “a person picking many gift cards”), receive a video segment of a person performing that action, and then search for other images or video segments that include that person by using the person reidentification platform, such as images or video segments of that person at a different location. In this way, for example, the action detection platform may detect actions in particular video segments, and the person reidentification platform may detect a common person across different locations or cameras.

Aspects of the present disclosure provide various technical advantages. For example, aspects of the present disclosure may efficiently process vast quantities of video data by implementing multiple layers of filtering. For example, the person reidentification system, by selecting best video frames from a plurality of video frames and by filtering candidate images based on inter-location travel feasibility and user-defined parameters, may reduce the number of candidate images to consider for a person reidentification engine. As another example, an action detection system, by performing multiple layers of filtering based on, for example, motion events and dwell time, may narrow the quantity of video data that is analyzed for actions, while still being able to use cameras that continuously monitor locations. Moreover, the action detection system may detect actions or events in particular video segments of the analyzed video data, thereby narrowing the video segments provided to a downstream consumer from a near continuous stream of video data to discrete video segments of interest that may have a duration of minutes, not hours. Because of these efficiencies, the person reidentification system and action detection platform may be deployed in an enterprise with many locations to monitor (e.g., hundreds or thousands of locations), each of which may have a plurality of cameras, and each of which may be continuously monitored.

Yet still, the accuracy of the person reidentification system and action detection systems disclosed herein may be an improvement to the accuracy and usability of previous systems. For example, the person reidentification system, by selecting a best image of person, generating embeddings for the image and for candidate images, and comparing the embeddings to determine nearest neighbors and a potentially matching person, may efficiently and accurately reidentify an image of a person. Moreover, via an interactive dashboard, a user may select an image of a person to reidentify, candidate images, and parameters, such as a threshold similarity values, that are used when identifying matches. Regarding the action detection platform, the use of a multi-modal machine learning model to map video and text data to a shared embedding space may enable a user to flexibly define (e.g., using a text string) an action or event of interest, and the action detection platform may accurately detect that action in a subset of video segments that are analyzed.

Yet still, components described herein may safeguard the privacy of individuals. For example, though images of a person may be matched to reidentify the person, the person reidentification platform may be able to perform such a reidentification without determining an identity of the person. As such, in some embodiments, the person reidentification platform does not use personally identifying or sensitive biometric data of a person to perform a person reidentification task. Similarly, the action detection platform may identify an action of a person without determining an identify of the person.

Yet still, aspects of the present disclosure enable matching of images captured from different locations. By leveraging computer vision, pattern recognition, and machine learning, aspects of the present disclosure provide a versatile solution that can be applied to a wide range of problems, enhancing efficiency and accuracy in the domain of computer processing of images and videos. Such improvements may further improve systems that use video processing techniques, such as security systems. As will be recognized by those having skill in the art, these are only some of the advantages that may be attained by using aspects of the present disclosure.

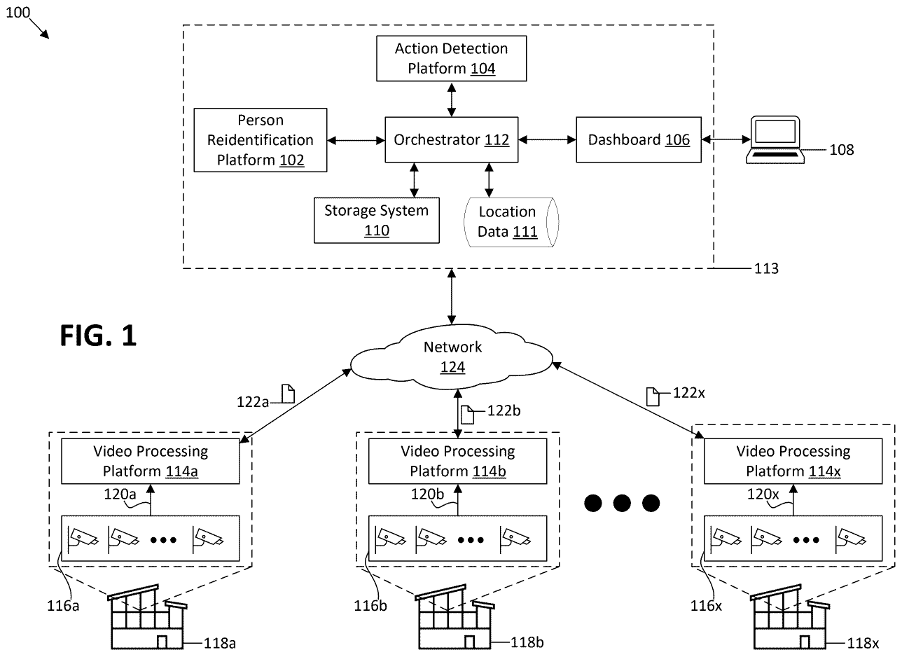

FIG. 1 illustrates an example network environment 100 in which aspects of the present disclosure may be implemented. In the example shown, the environment 100 includes a person reidentification platform 102, an action detection platform 104, a dashboard 106, a computing device 108, a storage system 110, location data 111, an orchestrator 112, a plurality of video processing platforms 114a-x, a plurality of cameras 116a-x, a plurality of locations 118a-x, and a network 124. In the example shown, the person reidentification platform 102, the action detection platform 104, the dashboard 106, the storage system 110, the location data 111, and the orchestrator 112 are implemented in a data center 113. The environment 100 may include more or fewer components than those illustrated in the example of FIG. 1.

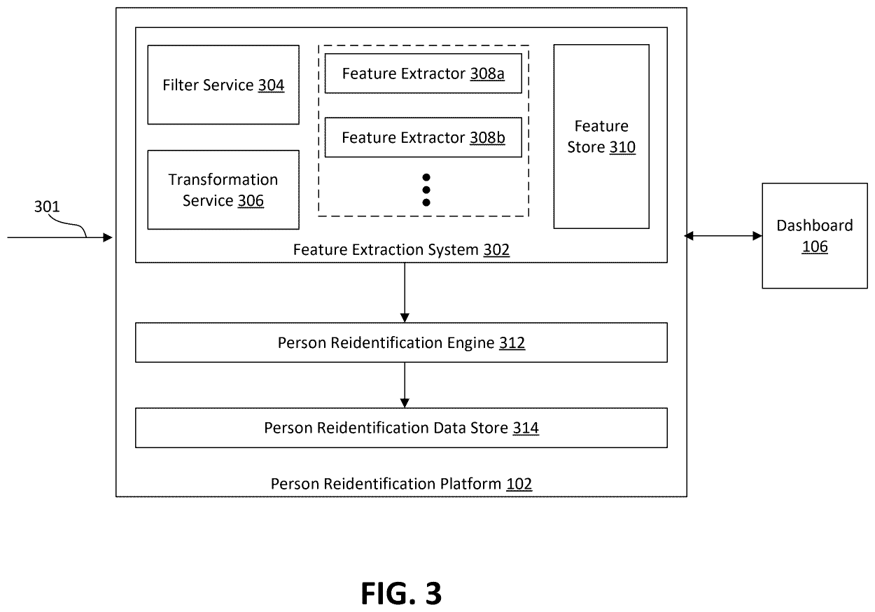

The person reidentification platform 102 may include hardware and software to perform a computer vision task that involves recognizing individuals across different times or locations. For example, the person reidentification platform 102 may recognize and match an image of a person captured by a first camera at a first location with an image of the person captured at a second camera or a second location. When a match is found, the person reidentification platform 102 may pair the images of the person and associate the images with an identifier corresponding to the person In some embodiments, the person reidentification platform 102 may perform a person reidentification task to identify individuals across the locations 118a-x. In some embodiments, the person reidentification platform 102 may recognize an individual at different cameras of a common location (e.g., different cameras of the location 118a) or at different times at a common camera or location. An example architecture of the person reidentification platform 102 is illustrated and described below in connection with FIG. 3.

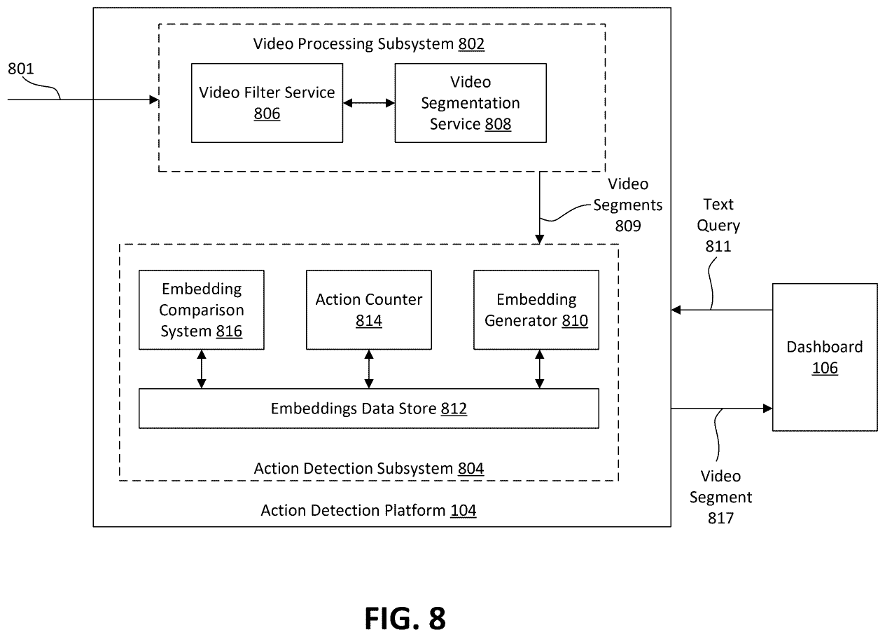

The action detection platform 104 may include hardware and software for detecting an action in a video. In some embodiments, the action detection platform 104 may detect action in videos captured by the cameras 116a-x. In some embodiments, the action detection platform 104 may use a multi-modal machine learning model to generate embeddings for a video segment and for a text string corresponding to an action. Based on a comparison of the embeddings, the action detection platform 104 may determine whether the video segment includes the action. In some embodiments, the action detection platform 104 may define and trigger events that include a detection of an action, and when an event is triggered the action detection platform 104 may provide data corresponding to a video segment to an event consumer. In some embodiments, operations or components of the person reidentification platform 102 and the action detection platform 104 may overlap. An example architecture of the action detection platform 104 is illustrated and described below in connection with FIG. 8.

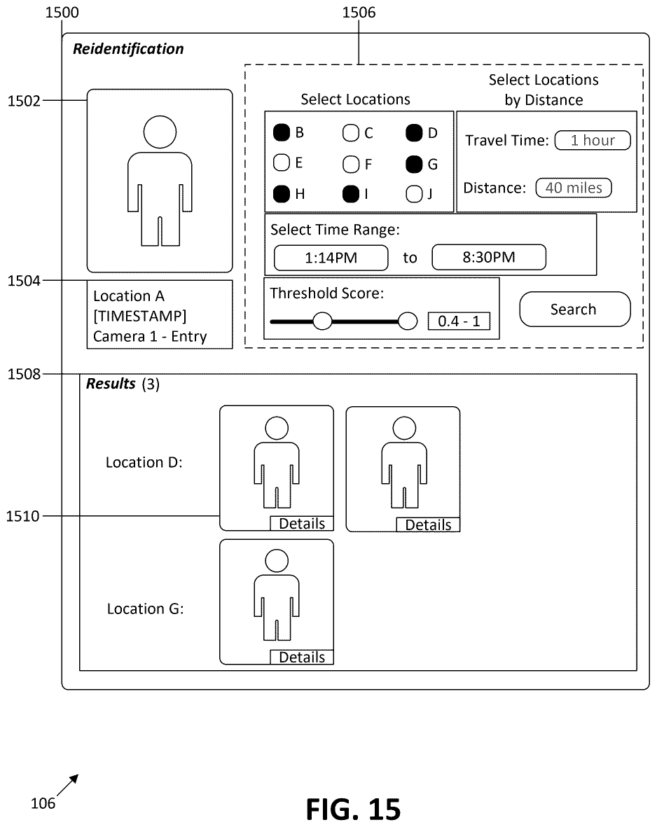

The dashboard 106 may be a frontend application that includes user interfaces for displaying data and receiving inputs from users. In some embodiments, the dashboard 106 is part of a web application. In some embodiments, the dashboard 106 is part of an application that can be downloaded to one or more of a worker or administrator device. The dashboard 106 may be communicatively coupled with one or more of the person reidentification platform 102 and the action detection platform 104, and may facilitate data exchanges between these platforms and the computing device 108. In some embodiments, the dashboard 106 includes options for defining settings or parameters used by one or more of the person reidentification platform 102 or the action detection platform 104. Example user interfaces of the dashboard 106 are illustrated and described in connection with FIGS. 15-17.

The computing device 108 may be used to access the dashboard 106. The computing device 108 may be a computer, tablet, mobile phone, or other computing device. The computing device 108 may be used by one or more of an administrator, a worker at one of the locations 118a-x, security personnel, an engineer, or another person or system that uses data from one or more of the person reidentification platform 102 or the action detection platform 104.

The storage system 110 may receive and store data from the video processing platforms 114a-x. Such data may include video data, image data, text data, and communications from systems or personnel at the locations 118a-x. Furthermore, the storage system 110 may receive metadata associated with the videos and images sent by the video processing platforms 114a, such as date information, time information, a location identifier, a person identifier, or other data. In some embodiments, other components of the environment 100 may retrieve data from the storage system 110, such as the person reidentification platform 102, the action detection platform 104, the dashboard 106, or the video processing platforms 114a-x.

The location data 111 may be a database that stores data about the locations 118a-x. For example, the location data 111 may include geographical coordinates (e.g., longitude and latitude values) for each of the locations 118a-x. The location data 11 may also include other geographical data for each of the locations 118a-x, such as a region, state, metro, city, and the like. In some embodiments, the location data 111 may include distances between two or more of the locations 118a-x.

The distances may include, for example, the distances between geographical coordinates of the locations 118a-x, which may be measured in miles or kilometers. As another example, the distances may be measured based on miles or kilometers that would be driven to travel between locations. Furthermore, the distances may include travel times, such as a travel time between locations when driving, or when using other transportation means, such as walking, flying, or using public transportation. In some embodiments, the travel time is based at least in part on historical travel times. In some embodiments, the travel time is a range of time. As an example, for the locations 118a and 118b, the location data 111 may have coordinates for each of the locations, may have a distance of, for example, 12 miles between their respective geographical coordinates, 18 miles by driving, and an estimated travel time of 30 minutes between the locations 118a and l18b. In a similar manner, the location data 111 may include distances for a plurality of pairs of locations of the locations 118a-x.

In some embodiments, the person reidentification platform 102 may use the location data 111 as part of performing an inter-location reidentification task. For instance, if the person reidentification platform 102 matches images of a person captured at the location 118a with candidate images captured at other locations, then the person reidentification platform 102 may filter the candidate images based on the location data 111 and a timestamp of the images of the person at location 118a. For instance, for any location that is not the location 118a, the earliest candidate images that will be considered may depend on the travel time between the location 118a and that location, thereby setting a location-specific lower bound for times of candidate images to be considered from each location.

For example, if the images of the person at the location 118a are captured at 10:15 AM, and if the travel time between the location 118a and the location 118b in the location data 111 is 30 minutes, then the earliest candidate images that the person reidentification platform 102 may consider from the location 118b may be at 10:45 AM. In some embodiments, the person reidentification platform 102 may determine, based on the location data 111, that the person at the location 118a would have been unable to travel to a given different location within a time frame. Accordingly, the person reidentification platform 102 may remove all images from that different location as candidate images for reidentifying the person that was at the location 118a. In some embodiments, the candidate images to be considered with the latest timestamps may be, for example, twenty-four hours after the images at the location 118a are captured, an end of the day, or another time that defines an upper bound for the latest candidate images to consider.

Advantageously, by filtering candidate images in a location-specific manner that may be based on travel times, the person reidentification platform 102 may more efficiently perform an inter-location person reidentification task without diminishing accuracy. For example, fewer candidate images may be considered, which may improve the speed at which the person reidentification platform 102 can determine whether a query image has a match, since candidate images that could not possibly match the query image may be discarded. Such efficiency improvements may be particularly advantageous for an enterprise with computational constraints and that is associated with many locations and cameras to monitor.

The orchestrator 112 may facilitate operations and data exchanges between other components of the data center 113. For example, the orchestrator 112 may implement a messaging system between other components of the environment 100. In some embodiments, the messaging system uses a publisher-subscriber architecture. Additionally, the orchestrator 112 may schedule operations of one or more of the person reidentification platform 102 or the action detection platform 104, thereby managing resource utilization of the data center 113. In some embodiments, the orchestrator 112 may also perform other tasks, such as monitoring and logging, scaling of resources available to the person reidentification platform 102 and the action detection platform 104, and automating workflows.

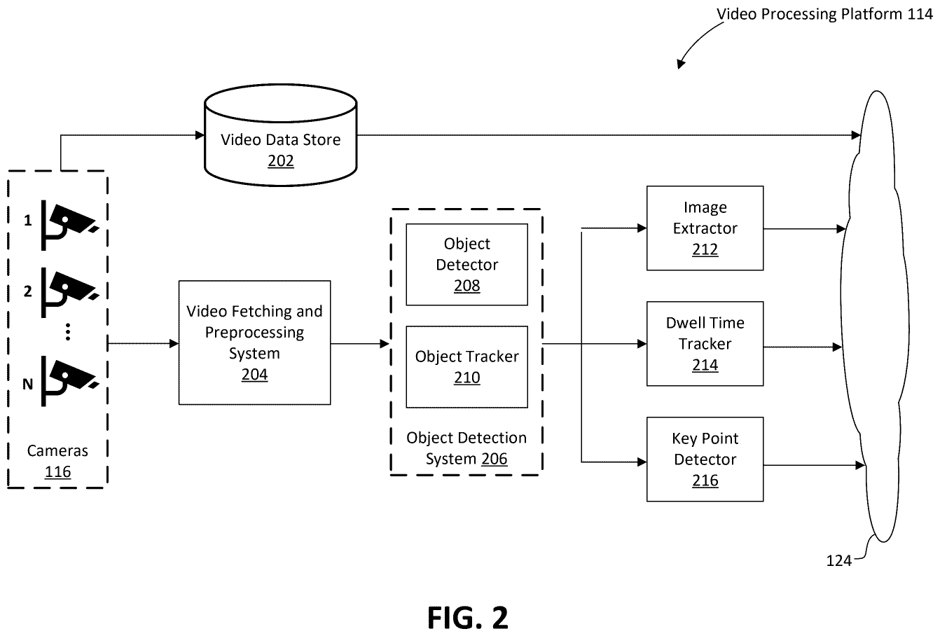

The video processing platforms 114a-x may include software and hardware for processing video and image data. As shown by the example of FIG. 1, each video processing platform of the video processing platforms 114a-x is associated with a location of the locations 118a-x. For example, the video processing platform 114a may be located on a premises of the location 118a. Each of the video processing platforms 114a-x may be communicatively coupled with components of the data center 113. Each of the video processing platforms 114a-x may be configured to receive video data 120a-x from respective cameras 116a-x of the respective location of the locations 118a-x, process the video data, and provide data 122a-x to the storage system 110 or another component of the data center 113, where the data 122a-x may include image data, video data, metadata, or other data. Depending on the context, reference herein to the video processing platform 114 may refer to one of the video processing platforms 114a-x or to a group of video processing platforms 114a-x. An example architecture of a video processing platform 114 is illustrated and described in connection with FIG. 2.

The cameras 116a-x include groups of cameras across the plurality of locations 118a-x. Each group of cameras of the cameras 116a-x includes one or more devices for capturing image or video data. As an example, the cameras 116a may include a plurality of devices located at different locations of the location 118a, such as, for example, an entrance, an exit, a checkout area, and an area that includes items. The cameras 116a may further be communicatively coupled with one another as part of a monitoring or security system, and the cameras 116a may be communicatively coupled with the video processing platform 114a.

The locations 118a-x may be part of a group of locations that are operationally coupled with components of the data center 113. In some embodiments, the locations are nodes in a retail supply chain. For example, the locations 118a-x may be retail stores. Each of the locations 118a-x may include locations or areas that are monitored by the respective cameras 116a-x. In some embodiments, each of the locations 118a-x is associated with a common entity, such as a common retailer.

The network 124 may communicatively couple components of the network environment 100. In some embodiments, some components that are implemented in the data center 113 are communicatively coupled with one another via the network 124. The network 124 may be, for example, a wireless network, a wired network, a virtual network, the internet, or another type of network. Furthermore, the network 124 may include subnetworks, and the subnetworks may be different types of networks or the same type of network.

FIG. 2 illustrates a schematic diagram of components of an example video processing platform 114 of the video processing platforms 114a-x. The video processing platform 114 may be located on the premises of an example location 118 of the locations 118a-x. In the example shown, the video processing platform 114 includes cameras 116, video data store 202, video fetching and preprocessing system 204, an object detection system 206 including an object detector and an object tracker 210, an image extractor 212, a dwell time tracker 214, and a key point detector 216. In some embodiments, one or more of the components illustrated in the example of FIG. 2 may be implemented as software or a combination of software and hardware.

The cameras 116, which may be examples of the cameras 116a-x of FIG. 1, may be positioned at different positions at a location 118. As an example, the cameras 116 may operate as part of a security system at a retail location 118, wherein the cameras 116 may be positioned within and have fields of view encompassing respective parts of the retail location 118. The cameras 116 may operate to obtain image data associated with their field of view and communicate the image data to one or more other systems. The image data may include a plurality of video frames captured in sequence according to a frame rate. For example, image data may capture an image of a person or multiple people in any given video frame. In some examples, at least two cameras may have overlapping fields of view, where an image of a person may be captured concurrently by the at least two cameras. In other examples, at least two cameras may be positioned to have adjacent fields of view, where an image of a person may be captured by a first camera and then subsequently captured by a second camera. In some examples, the image data captured by the cameras 116 may be collected by the video fetching and preprocessing system 204. In some examples, video and image data captured by the cameras 116 may further be stored in a video data store 202, which may, in some embodiments, provide the video and image data to the data center 113 via the network 124.

In some embodiments, the video processing platform 114 may operate to track a person at a location 118 across multiple cameras 116, while maintaining temporary identification of the person through that person's overall visit at the location 118. Specifically, while the person may not be personally identified, that person's presence in video frames captured by different cameras 116 from different perspectives may be linked together, thereby performing an intra-location person reidentification task. In some embodiments, the video processing platform 114 may further process image or video data, and this data may be evaluated, for example, by one or more of the person reidentification platform 102 or the action detection platform 104, which may be in communication with the video processing platform 114.

The video fetching and preprocessing system 204 may be operative or configured to receive video data from the cameras 116. In one example, the video data may include a plurality of video frames captured by a camera of the cameras 116. The video data may include captured images of a person or a plurality of people. In some examples, the video fetching and preprocessing system 204 may operate on an independent thread. In some examples, the video fetching and preprocessing system 204 may operate to receive video data from a plurality of cameras of the location 118. In some examples, multiple video fetching and prepressing systems 204 may operate to fetch video data from a subset of the plurality of cameras 116 included at the location 118.

In some examples, the video fetching and preprocessing system 204 may be configured to fetch or otherwise receive video frames from the cameras 116 at a preconfigured frame limit. In some examples, the video fetching and preprocessing system 204 may operate to receive video frames at the same or near the frame rate of the camera 116 (e.g., 10, 20, 30 frames per second). That is, in some examples, the video fetching and preprocessing system 204 may operate in real time or near-real time. In some embodiments, the video fetching and preprocessing system 204 may retrieve video data from the video data store 202. In some instances, the video fetching and preprocessing system 204 may retrieve archived video data. In some instances, the video fetching and preprocessing system 204 may stream data from one or more of the video data store 202 or the cameras 116.

Once the video fetching and preprocessing system 204 receives video data, various preprocessing tasks may be performed. Such tasks may include but are not limited to, the following: frame extraction, background subtraction, resolution resizing, cropping video frames, adjusting pixel values to a normalized scale or range, denoising, data format conversion, metadata handling or generation, or another task. The video fetching and preprocessing system 204 may provide processed video data to the object detection system 206, which includes the object detector 208 and the object tracker 210.

The object detector 208 may detect motion events in video data and generate bounding boxes that include people in video frames. To detect motion events, the object detector 208 may compare video frames to identify differences. Based on the identified differences, the object detector 208 may identify when motion occurs in the video data and where the motion occurs in video frames. In some embodiments, the object detector 208 may discard video frames in which no motion is detected. For example, the object detector 208 may not process such video frames further. To generate bounding boxes, the object detector 208 may, in some embodiments, use a machine learning model to generate one or more bounding boxes that include one or more people in a video frame. In some embodiments, as part of generating bounding boxes, the object detector 208 may predict whether a set of pixels corresponds to a person.

In some examples, the object tracker 210 may receive video frames and bounding boxes determined by the object detector 208. The object tracker 210 may operate to track detected people from a previous video frame and for a series of frames. This may include assigning, in a first video frame, an identifier to a bounding box that includes a person and then, in a subsequent video frame, determining whether a bounding box is associated with the same identifier and person as the previous video frame. If so, that person is tracked across video frames. For example, if visual features are matched, an ID of the previous frame may be assigned to the current bounding box. If the visual features are not matched, a new ID may be generated and assigned. In some embodiments, by tracking a bounding box across at least two video frames in the video data, the object tracker 210 determine a plurality of available images of a person.

In some embodiments, the object tracker 210 applies a convolutional neural network that extracts visual features from a detected bounding box, and a Kalman filter may be used to predict a person's speed and direction to correctly correlate a person in a current frame with the same person in a previous frame.

The object detection system 206 may provide one or more of image or video data to the components 212-216. Furthermore, the object detection system 206 may provide information about the image or video data, such as bounding boxes and data generated by the object tracker 210 as part of tracking a bounding box across a plurality of video frames. The components 212-216 may further process the image or video data received from the object detection system 206.

The image extractor 212 may, from a plurality of video frames, select one or more images of a person. The image extractor 212 may then provide the one or more images of the person to a component of the data center 113. In some embodiments, images selected by the image extractor 212 may be used by the person reidentification platform 102 to reidentify a person across multiple locations.

In some embodiments, the image extractor 212 may identify a plurality of available images that are available for a person, such as the plurality of video frames across which the object tracker 210 tracked a bounding box. From the plurality of available images, the image extractor 212, may select one or more images. In some embodiments, the image extractor 212 may select one or more images with a highest image quality. In some embodiments, the image extractor 212 may apply one or more transformations to the selected images, such as, for example, cropping, rotating, aligning, segmenting, posing, masking, or another image processing operation.

In some embodiments, the image extractor 212 may select one or more images based on detected facial features of the person in the available images. For example, the image extractor 212 may apply a program to detect facial features of the person in the available images and based on metrics associated with the detected facial features, the image extractor 212 may select one or more images. Example metrics associated with the facial features may include face sharpness, size, or ratio. Example metrics associated with the facial features may also include a face orientation (e.g., whether the person is facing forward or whether the person is facing to a side, thereby providing a left or right profile). In some embodiments, even if facial recognition is not being performed, selecting best images based on detected facial features may enable the image extractor 212 to select a diverse and high-quality set of images that may be used for a downstream person reidentification task.

The dwell time tracker 214 may determine a dwell time of a person at an area. For example, based on data from the object tracker 210, the dwell time tracker may determine that a given person is present across a plurality of video frames. The dwell time tracker 214 may determine the person's location within the plurality of video frames. Based on times (e.g., timestamps) associated with the video frames, the dwell time tracker 214 may determine an amount of time that the person was present in an area of interest. For example, the dwell time tracker 214 may subtract a first timestamp associated with a first video frame that the person is in the area from a last timestamp associated with a last video frame that the person is present in the area. The area may be defined, for example, by a worker of the location 118 or by an administrator associated with the data center 113 or the video processing platform 114. As examples, the area may be an entrance, exit, checkout location, merchandise location, or other area of interest. The dwell time tracker 214 may provide dwell times, along with an identifier of a location, area, or person for which the dwell time is calculated to a component of the data center 113, such as the storage system 110.

The key point detector 216 may detect a key point of a person in video frames and may determine metrics associated with the key point. A key point may be, for example, an attribute of interest of a person in the video data. Example key points include hands, fingers, elbows, knees, head, or facial features. In some embodiments, to detect key points, key point detector 216 may estimate a pose of a person across video frames, and based on the detected pose, estimate where the person's key points are located. In some embodiments, the key point detector 216 may apply a machine learning model to detect key points. For example, the key point detector 216 may use a YOLO (Your Only Look Once)-based model.

Furthermore, the key point detector 216 may, in some embodiments, derive one or more metrics associated with key points. For example, by tracking key points across a plurality of video frames, the key point detector 216 may determine characteristics of the key points. For instance, if a key point is hand, then the key point detector 216 may detect a location of the hand, whether the hand moved, and if so, how far and at what velocity the hand moved. In some embodiments, the identified key points and the derived metrics associated with the key points may be used as part of performing an action recognition or person reidentification task, or to filter video frames prior to performing such tasks.

FIG. 3 illustrates a schematic diagram of an example architecture of the person reidentification platform 102. In the example shown, the person reidentification platform 102 includes a feature extraction system 302, a person reidentification engine 312, and a person reidentification data store 314. The person reidentification platform 102 may include more or fewer components than those illustrated in connection with FIG. 3.

As shown by the example of FIG. 3, the person reidentification platform 102 may receive data 301 from the plurality of video processing platforms 114, such as data that is received, filtered, generated, or organized by a video processing platform 114, as described in connection with FIG. 2. In some embodiments, the person reidentification platform 102 may retrieve data from the storage system 110. In some embodiments, the person reidentification platform may receive the data 301 continuously and in real time as it is pushed to the data center 113 by the video processing platforms 114.

The feature extraction system 302 may include a filter service 304, a transformation service 306, feature extractors 308, and a feature store 310.

The filter service 304 and the transformation service 306 may be applied to images received from the video processing platforms 114. In some embodiments, each of the filter service 304 and the transformation service 306 may be implemented as microservices. In some embodiments, the filter service 304 may crop images received from the video processing platforms 114 or may perform other image processing operations. In some embodiments, the filter service 304 adjusts images so that differences across images resulting from different cameras or ambient conditions are minimized. For example, the filter service 304 may adjust a brightness level of images received from video processing platforms 114 based on a time of day at which the images are captured. In some embodiments, the transformation service 306 may perform one or more of a generative or a non-generative transform to the images. In some embodiments, the images may be GIF files or may be converted by the transformation service 306 to GIF files. In some embodiments, one or more of the filter service 304 or the transformation service 306 may alter images pursuant to input requirements of one or more of the feature extractors 308.

As shown by the example of FIG. 3, the feature extraction system 302 may include one or more feature extractors, as shown by the feature extractors 308a and the 308b. In some embodiments, each of the feature extractors 308 may be an application that receives an image and that outputs a feature vector, which may an embedding. A feature vector may be a vector of numbers that represents information about an image. In some embodiments, one or more of the feature extractors 308 may use a machine learning model configured to receive image data and encode that image data into a feature vector. In some embodiments, one or more of the feature extractors 308 may use a transformer architecture. In some embodiments, one or more of the feature extractors 308 may be pre-trained and then fine-tuned on data that has been collected and processed by the video processing platform 114. In some embodiments, one or more of the feature extractors 308 may be accessed using a microservice architecture.

In some embodiments, the feature extractor 308a and the feature extractor 308b (and other feature extractors of the feature extraction system 302) may be different machine learning models. As such, for a same image, different feature extractors may generate different feature vectors. Therefore, for a given image, a plurality of feature vectors may be generated and may, in some instances, be combined into a larger dimension feature vector for the image. Advantageously, different feature extractors of the feature extractors 308 may have different strengths (i.e., may be better able to distinguish certain image features than other image features), and by using a plurality of feature extractors, the strengths of multiple feature extractors 308 may be used. For example, the feature extractor 308a may be trained to generate feature vectors based on body parts identified in an image and the feature extractor 308b may be trained to generate feature vectors based on clothing. As another example, the feature extractor 308a may be trained using unsupervised learning, whereas the feature extractor 308b may be trained using supervised learning. Moreover, in some embodiments, another advantage of the architecture of the person reidentification platform 102 may be that feature extractors 308 can be flexibly added or removed in a plug-and-play fashion, thereby removing dependence on any particular feature extractor and enabling a change to how feature vectors are generated and, ultimately, how the person reidentification task may be performed.

The feature store 310 may include a database that stores feature vectors generated by the feature extractors 308. Furthermore, the feature store 310 may, for a given feature vector, store data associated with the feature vector, such as a corresponding image or set of images, a date, location, or other metadata. In some embodiment, the person reidentification engine 312 may retrieve feature vectors from the feature store 310 to perform a person reidentification task.

The person reidentification engine 312 may reidentify a person by using feature vectors associated with images. For example, the person reidentification engine 312 may compare images captured at different of the locations 118 to identify a person that visited two or more of the locations 118. For instance, the person reidentification engine 312 may compare a first image of a person to a plurality of candidate images, which may be images captured at a different location and which may or may not depict the person. Based on the comparison, the person reidentification engine 312 may identify the person in one or more of the candidate images, thereby reidentifying the person and determining that the person visited a location associated with the one or more candidate images. In some instances, the person reidentification engine 312 may reidentify a person across different locations, whereas in other instances, the person reidentification engine 312 may reidentify a person across different cameras of a single location.

Specifically, in some embodiments, the person reidentification engine 312 may receive an image of a person captured at first location. The person reidentification engine 312 may retrieve one or more feature vectors associated with that image generated by the feature vectors. The person reidentification engine 312 may also retrieve a plurality of feature vectors generated for the plurality of candidate images. The person reidentification engine 312 may then determine, for each feature vector associated with the person, nearest neighbor feature vectors from the plurality of feature vectors associated with the candidate images. For example, the person reidentification engine 312 may apply a nearest neighbor algorithm for each of the feature vectors associated with the image of the person. The nearest neighbor feature vectors may be associated with images that are similar to the image of the person, since they may be nearby (e.g., based on a Cosine or Euclidean distance) the feature vectors for the image of the person. The person reidentification engine 312 may determine whether a sufficient number of the similar images correspond to a common person. If so, the person reidentification engine 312 may determine that the person in the image corresponds to the common person in the similar images, thereby reidentifying the person. If, on the other hand, a sufficient number of the similar images do not correspond to a common person, then the person reidentification engine 312 may determine that there are no matches, and there may not be a reidentification.

As an example, a person reidentification platform 102 may receive an image of a person from the location 118a. A feature vector may be generated for that image. The person reidentification platform 102 may receive candidate images from the location 118b. Feature vectors may be generated for the candidate images. The feature vector for the image of the person at the location 118a may be compared to the feature vectors of the plurality of candidate images, resulting in nearest neighbor feature vectors of the plurality of feature vectors. For example, five nearest neighbor feature vectors may be identified. The images associated with the nearest neighbor feature vectors may be considered similar images to the image of the person at the location 118a. If a sufficient number of these similar images (e.g., greater than 30%, 50%, 70%, or another threshold value), correspond to the same person at the location 118b, then it may be determined that this person is, in fact, the person in the similar images that visited the location 118a. If, on the other hand, the similar images do not correspond to a common person at the location 118b, then it may be determined that there is not a reliable match at the location 118b.

In a similar manner, as described further herein, this technique may be expanded to include a plurality of feature vectors generated by a plurality of feature extractors (e.g., the feature extractor 308a and 308b) for the image of the person and for the plurality of candidate images. Furthermore, in a similar manner, as described further herein, this technique may be expanded to include a plurality of images of the person (e.g., if a plurality of best images are selected by the image extractor 212), for each of which feature vectors may be generated and compared to the feature vectors of the plurality of candidate images.

In some embodiments, the person reidentification engine 312 may filter the candidate images. For example, the person reidentification engine 312 may filter the candidate images based on a date or time. For example, if a first image of a person is captured at a first location at first date, then the person reidentification engine 312 may only select candidate images that have the same date or occur one day before or after. The person reidentification engine 312 may discard (i.e., not consider) images that do not fall within the requisite date range. Similarly, with time, the person reidentification engine 312 may filter images based on whether it is possible for the person to be present in the candidate images. For example, if the first image is captured at 10:00 AM, then the person reidentification engine 312 may discard candidate images from a second location that were captured between 9:50 AM and 10:10 AM, because the person reidentification platform may determine that is impossible for the person to have traveled between the first and second locations in less than ten minutes. In some embodiments, to make such determinations, the person reidentification engine 312 may consider, for example, geographical locations, travel times, and historical data. With respect to filtering by time, the person reidentification engine 312 may, in some instances, select candidate images within a time range from the first image, such as within an hour or another amount of time.

Furthermore, the person reidentification engine 312 may filter candidate images based on location. For example, for a first image captured at a first location, the person reidentification engine 312 may filter the candidate images to only include those images that are captured at locations with a range of the first location. For example, if a first image is captured at a first location in a first region, then the person reidentification engine 312 may only select candidate images of locations that are different from the first location but that are in the first region. A region may be, for example, a geographically defined region. At a more granular level, the person reidentification engine 312 may, in some embodiments, filter locations for candidate images based in part on geographical distances and travel times. For example, if a person is identified at retail store number 1 at 4:00 PM, and if all retail stores close at 5:00 PM, the person reidentification engine 312 may only select candidate images from stores that are within a one-hour travel distance from the first location, which may, in such an example, be the range from the first location. In some embodiments, the person reidentification engine 312 may filter candidate images based on a combination of one or more of date, time, locations, or travel distances.

In some embodiments, the person reidentification engine 312 performs person reidentification in batches. For example, the orchestrator 112, or another component, may schedule a time at which the person reidentification engine 312 performs reidentification. In some embodiments, the person reidentification engine 312 performs a reidentification task in response to receiving a request from a user via the dashboard 106.

The person reidentification data store 314 may receive data from the person reidentification engine 312 and the feature extraction system 302. Such data may include, for example, data corresponding to matches identified by the person reidentification engine 312. For example, if the person reidentification engine 312 matches a first plurality of images captured at a first location with a second plurality of images captured at a second location, then the person reidentification data store 314 may store a pairing of the first location and the second location. This paring may be assigned an identifier and associated with the plurality of matched images. In some embodiments, the dashboard 106 may exchange data with the person reidentification data store 314.

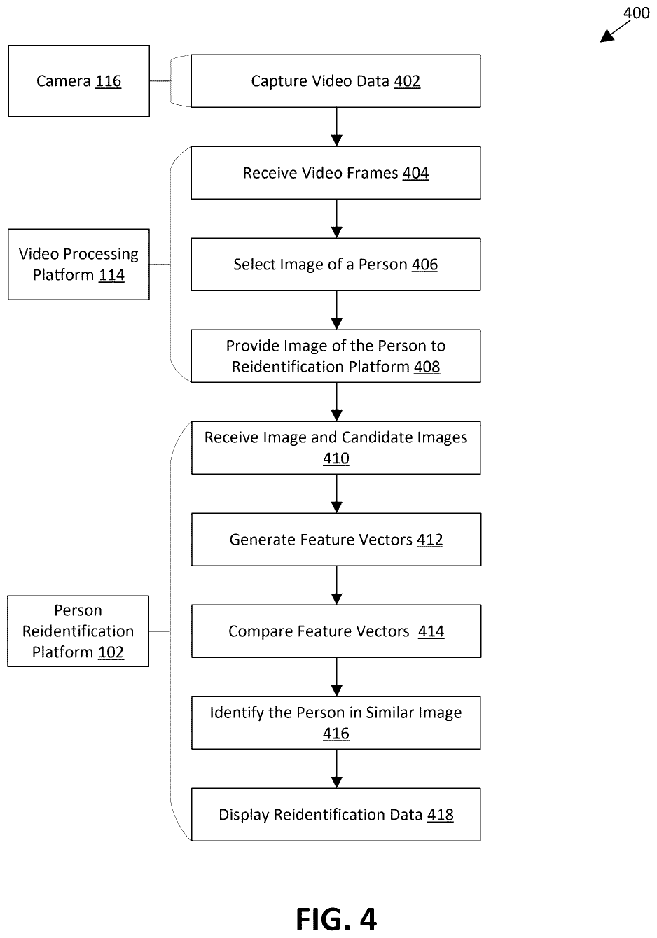

FIG. 4 is a flowchart of an example method 400 that includes example operations for reidentifying a person. As shown by the example of FIG. 4, different components of the network environment 100 may perform different operations of the method 400. However, operations of the method 400 are not limited to being performed by the corresponding components depicted in in the example of FIG. 4. For example, one or more operations described herein may be performed by a different component than described in the example of FIG. 4. Moreover, the method 400 may include more or fewer operations than those described in connection with FIG. 4.

In the example shown, a camera 116 may capture video data (step 402), as described, for example, in connection with FIG. 1-2. For example, one or more cameras may capture video data of an area of a location, such as an area of interest of a retail store. The one or more cameras may provide the video data to the video processing platform 114.

In the example shown, the video processing platform 114 may receive video frames from the camera 116 (step 404), as described, for example in connection with FIG. 2. For example, the video processing platform 114 may receive video data, which may include a plurality of video frames, at one or more of the video data store 202 or the video fetching and preprocessing system 204. In some embodiments, the video processing platform 114 may receive video data in batches (e.g., video data from a previous hour) or may continuously receive the video frames in real time.

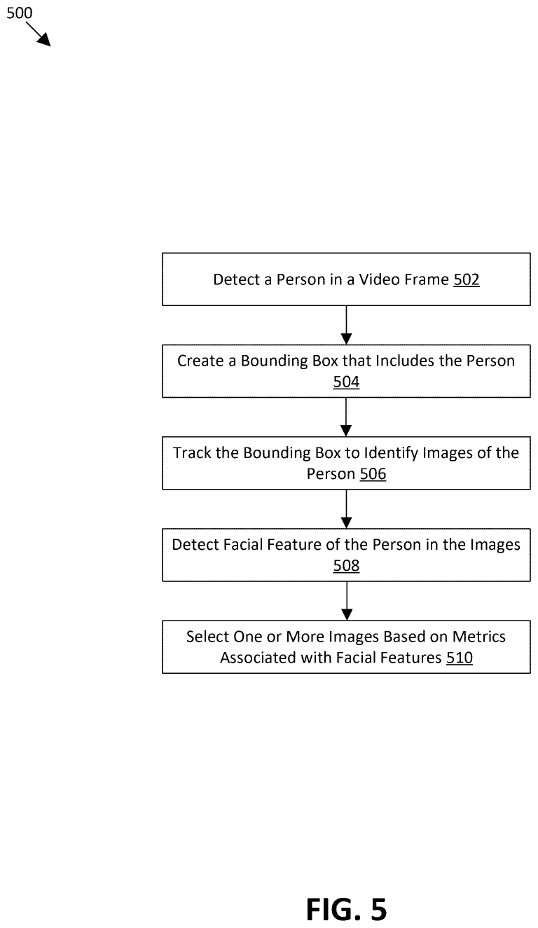

In the example shown, the video processing platform 114 may select an image of a person from the video frames (step 406). In some embodiments, the video processing platform 114 may select a plurality of images of the person. In some embodiments, the video processing platform 114 may select one or more images for a plurality of people captured in the video data. An example method for selecting a person in the video frames is illustrated and described in connection with FIG. 5.

In the example shown, the video processing platform 114 may provide one or more selected images of a person to the person reidentification platform (step 408). In some embodiments, the person reidentification platform 102 may provide one or more images of a plurality of people to the person reidentification platform 102. In some embodiments, the video processing platform 114 may also provide metadata (e.g., timestamps, data generated by devices at the location, or data generated by the video processing platform 114) to the person reidentification platform 102.

In the example shown, the person reidentification platform 102 may receive the selected one or more images from the video processing platform 114, and the person reidentification platform 102 may receive candidate images. In some embodiments, candidate images may be any images that are not the one or more selected images of the person. However, in some embodiments, the candidate images may be narrowed by, for example, the person reidentification platform 102. For example, the candidate images may be images that are received from a different location from the location at which the selected one or more images are captured. Furthermore, the candidate images may be narrowed based on one or more of a date, time, or a feasibility of whether the same person could have appeared in the selected one or more images and the potential candidate images. As shown by the example of FIG. 1, the person reidentification platform 102 may be communicatively coupled with a plurality of video processing platforms across a plurality of locations. If the selected one or more images are received from the video processing platform 114a at the location 118a, then the candidate images may be received from the video processing platform 114b at the location 118b. In some embodiments, as well as receiving images, the person reidentification platform114 may receive other data provided by the video processing platforms 114. The person reidentification platform 102 may also, in some embodiments, apply the filter service 304 and transformation service 306 to the image and the plurality of candidate images.

In the example shown, the person reidentification platform 102 may generate feature vectors (step 412). For example, for each of the one or more selected images, and for each of the candidate images, the person reidentification platform 102 may apply one or more of the feature extractors 308 to generate one or more feature vectors. The person reidentification platform 102 may then store the feature vectors in the feature store 310.

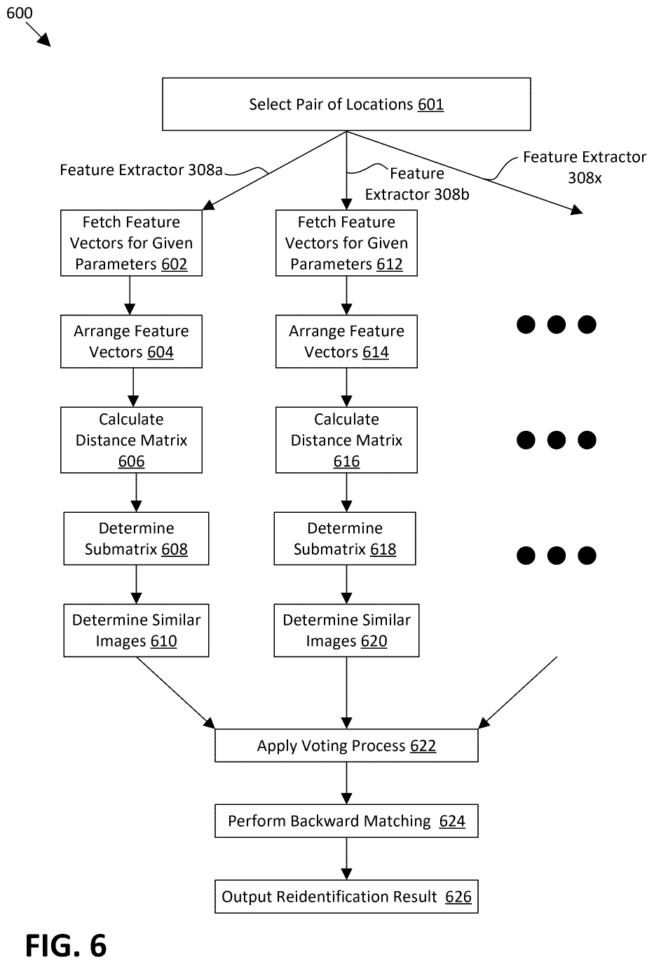

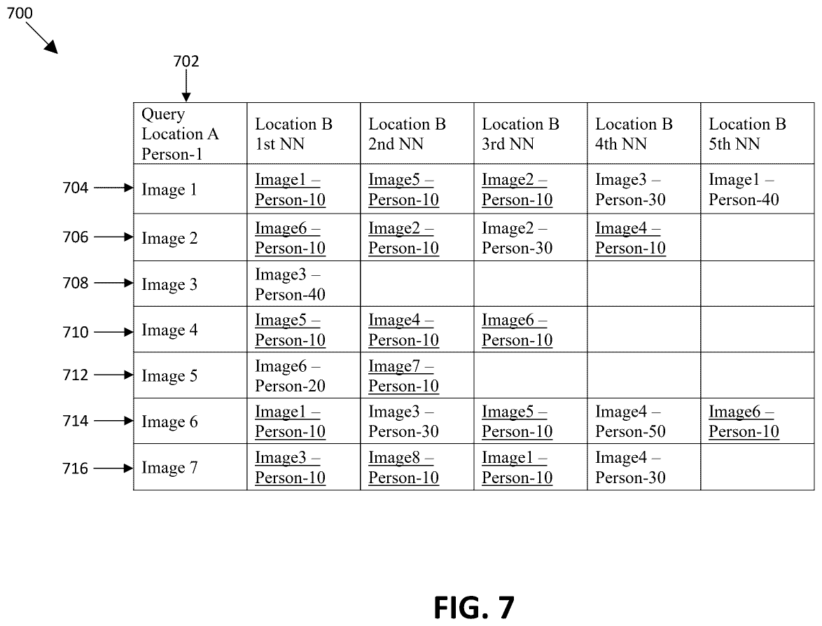

In the example shown, the person reidentification platform 102 may compare feature vectors (step 414). For example, the person reidentification platform 102 may apply the person reidentification engine 312 to compare the one or more feature vectors for the one or more selected images to the feature vectors for the plurality of candidate images. In some embodiments, such a comparison may include determining a distance between the one or more feature vectors for the one or more selected images and the feature vectors for the plurality of candidate images. In some embodiments, the comparison includes applying a nearest neighbor algorithm. By performing comparison of feature vectors, the person reidentification platform 102 may identify, from the plurality of candidate images, one or more similar images from the plurality of candidate images to the one or more selected images. Example aspects of comparing feature vectors are illustrated and described in connection with FIGS. 6-7.

In the example shown, the person reidentification platform 102 may identify a person in the one or more similar images (step 416). For example, each of the similar images may be associated with an identifier, such as metadata provided by a video processing platform, and this identifier may correspond to a person. As such, if two or more similar images have a same identifier, then the person shown in the two or more similar images may be the same person.

In some embodiments, if there is a single similar image to the one or more selected images, then the person in the single similar image is identified as the person in the one or more selected images. In some embodiments, if there are a plurality of similar images, then it is determined whether a threshold number of images of the plurality of similar images correspond to the same person. If so, then that person is identified as the person in the one or more selected images. For example, if ten similar images are identified as similar to the one or more selected images, and if the threshold value is 50%, and if seven of the ten similar images correspond to the same person, then that person may be identified as the person in the one or more selected images. Other threshold values are likewise possible. Moreover, other techniques for identifying a person in the one or more similar images are likewise possible.

In the example shown, the person reidentification platform 102 may display reidentification data via the dashboard 106 (step 418). For example, the person reidentification platform 102 may display one or more similar images that have been determined to include an image of the same person as the person in a query image, which may include one or more of the images selected by the video processing platform 114. The person reidentification platform 102 may also display data associated with a query image or the one or more similar images. Example data displayed by the dashboard 106 are illustrated and described in connection with FIGS. 15-17. In some embodiments, the person reidentification platform 102 may provide person reidentification data to other downstream systems, such as a security system, a video processing platform, or another application.

FIG. 5 is a flowchart of an example method 500 for selecting an image of a person. As described herein, one or more operations of the method 500 may be used by the video processing platform 114 to perform aspects of the operation 406 of FIG. 4. However, the operation 406 of FIG. 4 and the method 500 may include more or fewer operations than describe in connection with FIG. 5.

In the example shown, the video processing platform 114 may detect a person in a video frame (step 502). For example, the video processing platform 114 may apply the object detector 208 to detect a person in a video frame. For example, the video processing platform 114 may detect a motion event in one or more video frames, detect an object in the one or more video frames, and apply a machine learning model to classify the object as a person.

In the example shown, the video processing platform 114 may create a bounding box that includes the person (step 504). For example, the video processing platform 114 may apply the object detector 208 to generate a bounding box in the one or more video frames that includes the person. For example, the video processing platform 114 may apply a machine learning model to generate a bounding box that includes the person, and the bounding box may be assigned an identifier.

In the example shown, the video processing platform 114 may track the bounding box to identify images of the person in the bounding box (step 506). For example, the video processing platform 114 may apply the object tracker 210 to track the bounding box, and therefore the person, across a plurality of video frames. Each of the video frames may include an image of the person, resulting in the video processing platform 114 identifying available images of the person. An available image of the person may be an image captured by a camera or processed by the video processing platform that has been determined to correspond with the person.

In the example shown, the video processing platform 114 may detect facial features of the person in the images (step 508). For example, the video processing platform 114 may detect facial features of the person in the plurality of available images of the person. To do so, the video processing platform 114 may apply the image extractor 212. To detect facial features, the video processing platform 114 may apply a machine learning model that detects key points. Advantageously, although the video processing platform may detect facial features to select images to be used for reidentification, the facial features themselves may not be explicitly used by the person reidentification platform 102 to perform a reidentification task.

In the example shown, the video processing platform 114 may, from the one or more available images of a person, select one or more images of the person based at least in part on metrics associated with the detected facial features (step 510). For example, based on the metrics, the available images may be ranked, and based on the ranking, one or more images may be selected. In some embodiments, the video processing platform 114 may select the best image of the available images for each evaluated metric. Example metrics may include a face or image sharpness, person or face size, pixel ratio, or orientation, such as orientation of the person or the person's face in a direction of a camera or to a right or left of a camera. In some embodiments, the ranking and selection of images may include other factors apart from metrics associated with facial features. Having selected one or more images of the person, the person reidentification platform 102 may provide the one or more images to the person reidentification platform 102 and may not, in some embodiments, continue to process other available images of the person.

FIG. 6 is a flowchart of an example method 600. In some embodiments, the person reidentification platform 102 may apply operations of the method 600 to perform aspects of the operations 414 and 416 of FIG. 4. However, the operation 414 and 416 of FIG. 4 and the method 600 may include more or fewer operations than describe in connection with FIG. 6. In some embodiments, operations of the method 600 may be performed by the person reidentification engine 312.

In the example shown, the person reidentification platform 102 may select a pair of locations (step 601). For example, the person reidentification platform 102 may receive a selection of a pair of locations from a user via the dashboard 106. In some embodiments, the pair of locations may belong to an enterprise that includes a plurality of locations, such as, for example, the locations 118a and 118b of FIG. 1. In some embodiments, the person reidentification platform 102 may receive more than two locations. In some embodiments, the person reidentification platform 102 may also select one or more of a date or time. In some embodiments, the person reidentification platform 102 may search for any image matches, or reidentifications, between the pair of selected locations. In some embodiments, the person reidentification platform 102 may use one or more query images to search for matches of a person in the one or more query images in one or more locations of the pair of locations.

In some embodiments, for each feature extractor of the plurality of feature extractors 308a-x, the person reidentification platform 102 may perform a set of operations to determine similar images based on feature vectors generated by respective feature vectors of the feature extractors 308a-x. For example, for the operations 602-610, the person reidentification platform 102 may use feature vectors generated by the feature extractor 308a, as shown by FIG. 6. As another example, for the operations 612-620, the person reidentification platform 102 may use feature vectors generated by the feature extractor 308b, as shown by FIG. 6. In a similar manner, the person reidentification platform 102 may use feature vectors generated by other feature extractors, such as, for example, a feature extractor 308x. For example purposes, the operations 602-610 associated with feature vectors from the feature extractor 308a are further described herein, but it should be understood that analogous operations 612-620 may likewise be performed using feature vectors determined by the feature extractor 308b, as shown by FIG. 6.

In the example shown, the person reidentification platform 102 may fetch feature vectors for the given parameters (step 602). For example, the person reidentification platform 102 may fetch feature vectors from the feature store 310 that were generated by the feature extractor 308a. The parameters may be a filter for selecting which feature vectors to fetch. The parameters may include the locations of the selected pair of locations. The parameters may include a date or time. The parameters may include inputs received at the dashboard 106.

In the example shown, the person reidentification platform 102 may arrange the fetched feature vectors (step 604). For example, for each location, the person reidentification platform 102 may arrange the feature vectors by a snapshot time, which may be the time that the corresponding image was captured.

In the example shown, the person reidentification platform 102 may calculate a distance matrix (step 606). For example, the person reidentification platform 102 may determine a distance between each feature vector of the fetched feature vectors. To calculate distances, the person reidentification platform 102 may use one or more of Cosine distance, a Euclidean distance, or a different technique. In some embodiments, the person reidentification platform 102 may only calculate distances between feature vectors associated with images captured at different locations.

In the example shown, the person reidentification platform 102 may determine a submatrix (step 608). Determining a submatrix may include selecting a subset of values of the distance matrix calculated during the step 606. In some embodiments, the submatrix may be determined based in part on a time range. In some embodiments, the submatrix may be based at least in part on a travel time between the locations of the selected pair of locations. In some embodiments, the submatrix may be based on a possibility of traveling between the pair of locations within a time range. For example, if a first feature vector is associated with an image captured at 2:05 PM at location 118a, if a second feature vector is associated an image captured at 2:15 PM at location 118b, and if a travel time between the location 118a and 118b is between 20-30 minutes, then the person reidentification platform 102 may remove the distance between the first feature vector and the second feature vector from the distance matrix as part of determining the submatrix. In some embodiments, the person reidentification platform may adjust a time range that is used to determine the submatrix based on a size of the submatrix, or based on a number of images that are being compared. For example, if a feature vector is being compared with a number of feature vectors that is above a threshold (e.g., 500 or another number), then the time range may be narrowed to reduce the number of feature vectors, and therefore the number of images, that are being compared. Other examples of filtering by one or more of time or distance are further described in connection with the person reidentification engine 312 of FIG. 3.

In the example shown, the person reidentification platform 102 may determine similar images (step 610). For example, based on the submatrix of distances, the person reidentification platform 102 may determine similar images. For instance, for a feature vector of given image, the person reidentification platform 102 may select the closest N feature vectors in the submatrix, and the similar images may be selected as the N images corresponding to the N feature vectors, where “N” is a number, such as a number between one to twenty, that may vary depending on the embodiment. In a similar manner, for a plurality of images for a plurality of feature vectors, a closest N images may be selected for each image of the plurality of images. In some embodiments, the submatrix includes only feature vectors that are sufficiently close to one another, as defined, for example, by a pre-determined threshold. In some embodiments, determining similar images comprises performing a nearest neighbor search algorithm.

In the example shown, the person reidentification platform 102 may apply a voting process (step 622). For example, the person reidentification platform 102 may receive the distance submatrices and similar images identified based on feature vectors generated by each of the feature extractors 308a-x. The person reidentification platform 102 may combine aspects of this data to identify similar images. To do so, the person reidentification platform 102 may apply a voting process. For example, for a given image, the person reidentification platform 102 may aggregate the similar images that have been identified for that image. If a sufficient number of the aggregated similar images correspond to a common person, then it may be determined that the common person is the person in the similar images, as described, for example, in connection with the operation 416 of FIG. 4. Similarly, for a plurality of images that correspond to a person that is being reidentified, a plurality of similar images for each of the plurality of images may be aggregated, and the collection of the plurality of similar images for each of the plurality of images may be evaluated to identify a person in the similar images who corresponds to the person in the plurality of images. Advantageously, in some embodiments, by aggregating similar images using feature vectors derived by different feature extractors 308a-x, the person reidentification platform 102 may more accurately reidentify a person by more fully accounting for different image characteristics that respective feature extractors of the feature extractors are trained to detect and distinguish.

In the example shown, the person reidentification platform 102 may perform a backward matching (step 624). For example, for a given image for which a similar image is identified, the person reidentification platform 102 may perform a matching process using the similar image as the query image and the given image as one of a plurality of candidate images. The person reidentification platform 102 may then determine a likelihood that the given image is determined, from the plurality of candidate images, as matching the similar image. If the likelihood is sufficiently high, then the person reidentification platform 102 may determine that the similar image and the given image do, in fact, correspond with the same person. In a similar manner, the person reidentification platform 102 may perform a backward matching process for a plurality of images corresponding to a person and a plurality of identified as including the person.

In some embodiments, when performing a backward matching with a plurality of images, proxy images may be used. For example, if each of a first and second image are known (e.g., based on a metadata identified) to correspond with a person, and if a third image is identified as a similar image to the second image, then when performing a backward match with the third image, the first and second images are proxies for one another, meaning that a match of the third image with either the first or second image will count as affirming that the person in the second and third images are the same person. Other optimizations when performing a backward matching process are likewise possible. In some embodiments, to perform the backward matching, the person reidentification platform 102 may perform one or more of the operations described in connection with the steps 602-610 or described in connection with the steps 410-418.

In the example shown, the person reidentification platform 102 may output the reidentification result (step 626). For example, the person reidentification platform may output data that is used or generated during one or more of the operations of FIG. 6. As an example, such data may be output via the dashboard 106 or may be output to another system.

FIG. 7 illustrates a table 700 showing example data corresponding to similar images to a plurality of query images. As an example, the table 700 may illustrate a result of determining a submatrix of distances for a plurality of feature vectors and of determining similar images by using the submatrix, as described, for example, in connection with the operations 608 and 610 of FIG. 6.

In the column 702, the table 700 includes data corresponding to query data. The query data may be data corresponding a person for which the person reidentification platform 102 is identifying matching images. For example, the query data may include images of a person captured at an example Location A, and the person may be assigned an identifier of Person-1. As shown, there are seven images of the Person-1 captured at the Location 1. As an example, the seven images may have been selected by the person reidentification platform 102, as described, for example in connection with FIG. 5.

In the example shown, the person reidentification platform 102 determines whether there is a match for the Person-1 in candidate images captured at the Location B. For each image of the query images, the table 700 includes one or more similar images, as shown by the rows 704-716. The similar images may be determined, for example, by applying a nearest neighbor (NN) algorithm comparing embeddings of representative images from Location A and Location B. As another example, the person reidentification platform 102 may determine Cosine similarities between embeddings of images from the Location A and the Location B to determine the similar images. For example, as shown by the row 704, the person reidentification platform 102 determines five similar images from a plurality of candidate images at the location B, which include the following: Image1—Person-10; Image5—Person10; Image2—Person10; Image3—Person-30; and Image1—Person40. The similar images may be associated, for example, with feature vectors that were closest to a feature vector associated with the Image 1 of the Person-1 captured at Location A. As shown, each of the similar images may be associated with an identifier of a person, such as the Person-10, Person-30, or Person-40, which may correspond with people in images captured at the Location B. In a similar manner, each of the Images 2-7 may likewise be associated with one or more similar images.

Based on the similar images, it may be determined whether there is a match for the Person-1 at the Location B. As shown, of the similar images determined for the Images 1-7, sixteen images correspond to the Person-10, as shown by the underlined similar images in the table 700. Based on the number of similar images associated with a common person (e.g., the Person-10), the person reidentification platform 102 may determine that the Person-10 at Location B is the same person as the Person-1 at the Location A. This determination may be made after comparing the number of similar images to a threshold value. This determination may be assigned a confidence or likelihood value. This determination may be made even though at least some of the images identified as similar to the Images of the Person-1 did not correspond to the Person-10.

FIG. 8 illustrates a schematic diagram of an example architecture of the action detection platform 104. In the example shown, the action detection platform 104 includes a video processing subsystem 802 and an action detection system 804. The video processing subsystem 802 includes a video filter service 806 and a video segmentation service 808. The action detection subsystem 804 includes an embedding generator 810, an action counter 814, and an embedding comparison system 816.

The video processing subsystem 802 may receive data 801 from the plurality of video processing platforms 114, such as data that is received, filtered, generated, or organized by a video processing platform 114, as described in connection with FIG. 2. In some embodiments, the action detection platform 104 may retrieve data from the storage system 110. In some embodiments, the action detection platform 104 may receive the data 801 continuously and in real time as it is pushed to the data center 113 by video processing platforms 114.

The video filter service 806 may filter the data 801 received from the video processing platforms 114. In some embodiments, the video filter service 806 may filter the data based on characteristics derived by a video processing platform. For example, the video filter service 806 may select a subset of video data that includes movements of certain key points. For example, the video filter service 806 may filter the video data to include only video data that includes a person whose hand has been determined to have a movement velocity above a threshold value. In some embodiments, the video filter service 806 may filter based on other activity detected in the video data, such as dwell time or person location. In some embodiments, the video filter service 806 may filter the video data based on characteristics of the video data itself, such as a quality or lighting characteristic, or based on metadata of the video data, such as a date, time, or location.

The video segmentation service 808 may segment the video data, thereby creating a plurality of video segments, or chunks of video data. Each video segment may include a plurality of video frames. In some embodiments, the video segmentation service 808 segments videos based on time. For example, the video segmentation service 808 may segment the video into four second chunks, or into chunks having a different duration. In some embodiments, the video segments may be overlapping. In some embodiments, the video segmentation service 808 may segment videos based on video data metadata or based on data depicted in the video data. For example, the video segmentation service 808 may segment the video data based on a presence of a person detected in the video data, such as generating one or more segments that include that person. In some embodiments, the video segmentation service 808 may be configured to chunk video data in a different manner.

In some embodiments, the video filter service 806 and the video segmentation service 808 may be implemented as microservices. In some embodiments, the video processing subsystem may provide video segments 809 to the action detection subsystem 804.

The embedding generator 810, which may be part of the action detection subsystem 804, may receive data and generate an embedding corresponding to the received data. An embedding may be a vector of numbers that represents the received data. IN some embodiments, an embedding is a feature vector, and vice-versa. In some embodiments, the embedding generator 810 is a machine learning model or a plurality of machine learning models. In some embodiments, the embedding generator 810 implements a transformer-based architecture. In some embodiments, the embedding generator 810 may be a multi-modal machine learning model. For example, the embedding generator 810 may be configured to receive data from different modalities, such as text data or image data, and generate embeddings for the data in a shared latent space. In some embodiments, the shared latent space is a text embedding space or an image embedding space. In some embodiments, the embedding generator 810 may include a first machine learning model to generate embeddings for text data and a second machine learning model to generate embeddings for video data.

In some embodiments, the embedding generator 810 is pre-trained. For example, the embedding generator 810 may be pre-trained on a large amount of internet data. In some embodiments, the embedding generator 810 is trained using contrastive loss techniques. In some embodiments, the embedding generator 810 is fine-tuned by adding or training at least one or more layers of the embedding generator 810 by using data received or generated by a component of the network environment 100. In some embodiments, the embedding generator 810 is fine-tuned to recognize actions of people in a retail store, such as actions corresponding to interactions with items, actions corresponding to theft, actions at a self-checkout location, actions at an exit or entrance, or other actions in a retail store.

In the example shown, the embedding generator 810 receives video segments 809 from the video processing subsystem 802. For each video segment 809, the embedding generator may generate an embedding and then store the embedding in the embeddings data store 812. The embedding generator 810 may also associate each generated embedding with an identifier of the video segment from which the embedding is generated. Additionally, the embedding generator 810 may generate embeddings that correspond with actions. For example, the embedding generator 810 may generate an embedding corresponding to a text string that describes the action. The text string may be input into the embedding generator 810, which may generate an embedding corresponding to the text string. For example, a text string corresponding to an action may be “person furtively looking around before putting an item into a pocket.” The embedding generator 810 may generate an embedding for this text string and store it, for example, in the embeddings data store 812.

The embeddings data store 812 may include a database that stores embeddings generated by the embedding generator 810. Furthermore, the embeddings data store 812 may, for a given embedding, store data associated with the embedding, such as a corresponding video, image or set of images, a date, location, or other metadata. In some embodiment, the action counter 814 and the embedding comparison system 816 may retrieve embeddings from the embeddings data store 812 to detect an action or an event.

The action counter 814 may be an application that detects pre-defined actions in video segments. In some embodiments, a pre-defined action is defined by an administrator or engineer associated with the action detection platform 104. In some embodiments, the pre-defined action is defined at least in part by using a text string. For example, a pre-defined action may be a “pick” action, which may correspond to when a person picks an item from a shelf. For a given segment or plurality of segments, the action counter 814 may determine how many pick actions occur. To do so, the action counter 814 may, in some embodiments, compare embeddings corresponding to the video segments to an embedding corresponding to the pre-defined action. In response to determining that a video segment embedding is sufficiently similar to an embedding for the action, the action counter may determine that the action is present. As such, the action counter 814 may determine a number of times that the action occurs in a video segment or a plurality of video segments. In some embodiments, the action counter 814 may use the embedding comparison system 816 to compare embeddings for video segments and pre-defined actions.

The embedding comparison system 816 may compare embeddings generated by the embedding generator 810. In some embodiments, the embedding comparison system 816 may compare a first embedding associated with a video segment to a second embedding associated with an action. For example, the embedding comparison system 816 may determine a distance between the first embedding and the second embedding in a shared latent space. The distance may be based, for example, on a Cosine distance or a Euclidean distance. Based on the determined distance, the embedding comparison system 816 may determine a similarity score. Based on the similarity score, the embedding comparison system 816 may determine whether the video segment depicts the action. For example, the embedding comparison system 816 may compare the similarity score to a threshold value. In some embodiments, the threshold value may be set by a user of the dashboard 106, the threshold value may vary depending on the action, or the threshold value may be set by an administrator or engineer of the action detection platform 104. In some embodiments, if the similarity score is greater than the threshold value, then it may be determined that the video segment includes the action.

In the example of FIG. 8, the action detection platform 104 is communicatively coupled with the dashboard 106. For example, the dashboard 106 may receive a text query 811 from a user, and the text query 811 may describe an action or attribute for which the user is searching. The dashboard 106 may provide the text query 811 to the action detection platform 104. As an example, the embedding generator 810 may generate an embedding for the text query 811. The embedding comparison system 816 may compare the embedding for the text query 811 to embeddings generated for one or more video segments. Based on the comparison, the embedding comparison system 816 may identify one or more video segments 817 that include the action. The action detection platform 104 may then provide the one or more video segments 817 that include the action to the dashboard 106 to be accessed by the user.

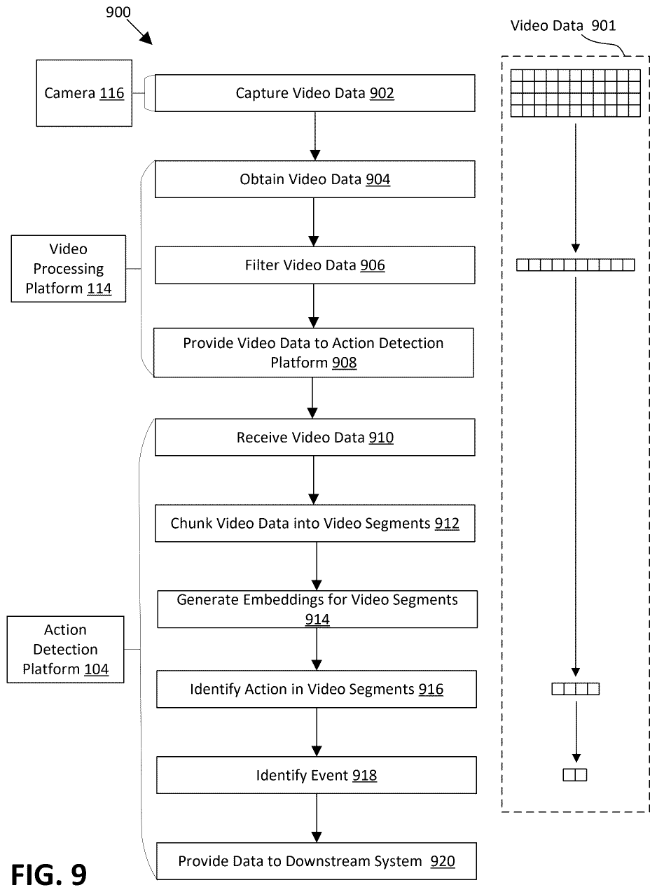

FIG. 9 is a flowchart of an example method 900 that includes example operations for detecting an action. As shown by the example of FIG. 9, different components of the network environment 100 may perform different operations of the method 900. However, operations of the method 900 are not limited to being performed by the corresponding components depicted in in the example of FIG. 9. For example, one or more operations described herein may be performed by a different component than described in the example of FIG. 9. Moreover, the method 900 may include more or fewer operations than those described in connection with FIG. 4.

The example of FIG. 9 includes a representation of video data 901. As described in connection with the operations of FIG. 9, the video processing platform 114 and the action detection platform 104 may process video data. In some embodiments, processing the video data may filter the video data, resulting in progressively less video data to be processed in subsequent operations or by subsequent systems. A schematic example of filtering the video data is illustrated by the video data 901, which depicts schematic blocks representing example quantities of video data. As shown, at an initial time, there may be a relatively large amount of video data to process. For example, at the operation 902, the camera 116 may capture a relatively large amount of video data, as shown schematically by the forty-four blocks of video data. At subsequent stages, there may be less video data 901 to process, as shown, for example, by the blocks of video data associated with the operations of filtering video data, identifying actions in video segments, and identifying events in video segments, which result in progressively less video data 901 to be processed in subsequent operations and improving the efficiency of subsequent steps. In some embodiments, other operations described herein may also reduce the amount of video data 901 to be processed at subsequent operations.

In the example shown, a camera 116 may capture video data (step 902), as described, for example, in connection with FIG. 1-2. For example, one or more cameras may capture video data of an area of a location, such as an area of interest of a retail store. The one or more cameras may provide the video data to the video processing platform 114.

In the example shown, the video processing platform 114 may receive video data from the camera 116 (step 904), as described, for example in connection with FIG. 2. For example, the video processing platform 114 may receive video data, which may include a plurality of video frames, at one or more of the video data store 202 or the video fetching and preprocessing system 204. In some embodiments, the video processing platform 114 may receive video data in batches (e.g., video data from a previous hour) or may continuously receive the video frames in real time.

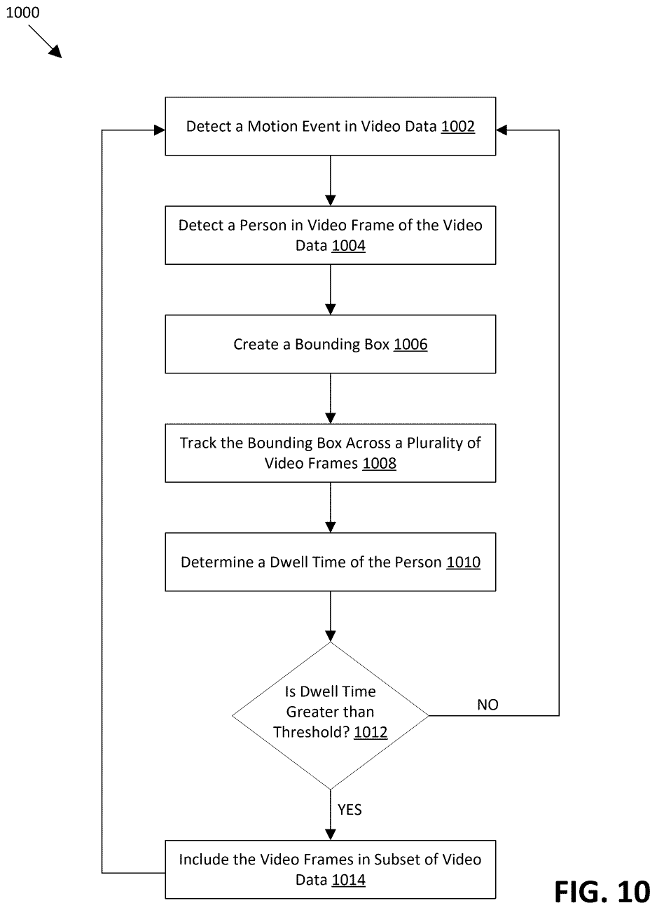

In the example shown, the video processing platform 114 may filter the video data (step 906). For example, the video processing platform 114 may apply one or more of the components 204-216 of FIG. 2 to filter the video data, thereby creating a subset of the video data to be provided to the data center 113. By filtering the video data, the video processing platform 114 may reduce the amount of the video data that is to be processed during subsequent operations, as shown by the video data 901 of FIG. 9. Example aspects of filtering the video data are illustrated and described in connection with FIG. 10.

In the example shown, the video processing platform 114 may provide the filtered subset of the video data to the action detection platform 104 (step 908). In some embodiments, the video processing platform 114 may also provide metadata (e.g., timestamps, data generated by devices at the location, or data generated by the video processing platform 114) to the action detection platform 104.

In the example shown, the action detection platform 104 may receive video data from the video processing platform 114 (step 910). In some embodiments, the action detection platform 104 may receive video data from a plurality of video processing platforms 114. Moreover, the action detection platform 104 may receive the metadata for the video data and other data collected or generated by the video processing platform 114. When receiving video data, the action detection platform 104 may organize and store the video data based on one or more of a location identifier, a camera identifier, a date, a time, or another metric.

In the example shown, the action detection platform 104 may chunk the video data into video segments (step 912). For example, the action detection platform 104 may apply one or more of the video filter service 806 or the video segmentation service 808 to generate video segments from the video data, as described, for example, in connection with FIG. 8.

In the example shown, the action detection platform may generate embeddings for the video segments (step 914). For example, the action detection platform 104 may apply the embedding generator 810 to one or more video segments of the plurality of video segments, thereby generating a plurality of embeddings. In some embodiments, the embedding generator 810 may concatenate or otherwise aggregate a plurality of embeddings corresponding to a plurality of video segments to generate an aggregate embedding for the plurality of video segments. In some embodiments, the action detection platform 104 may apply the embedding generator 810 simultaneously to a plurality of video segments to generate an embedding for the plurality of video segments.

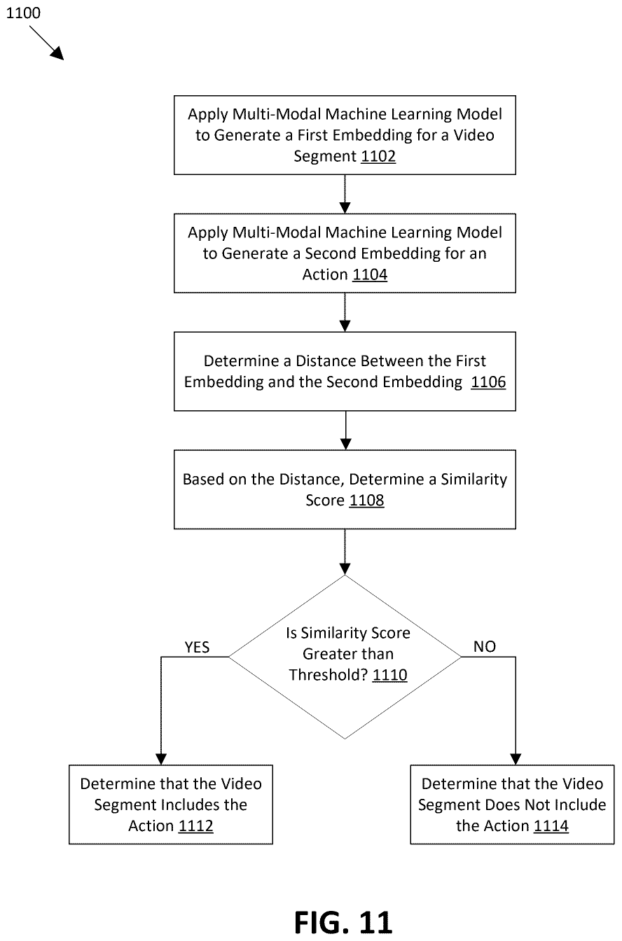

In the example shown, the action detection platform 104 may identify actions in video segments (step 916). For example, the action detection platform 104 may apply the embedding comparison system 816 to identify actions in video segments. As shown by the video data 901, identifying actions in video segments may further narrow the video data to be processed during subsequent operations. Example aspects of identifying an action in video segments are described in connection with FIG. 8 and are further illustrated and described in connection with FIG. 11.

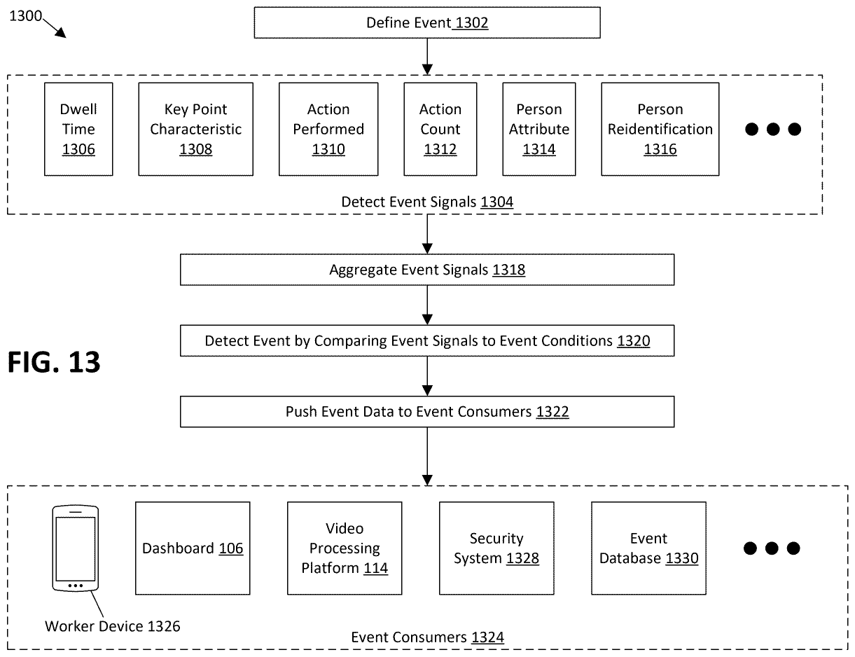

In the example shown, the action detection platform 104 may identify events in video segments (step 918). For example, the action detection platform 104 may define one or more conditions for events. If a video segment or a group of video segments meet the conditions for the event, then the action detection platform 104 may identify the event in the video segment. Example conditions may include one or more of an identification of an action, a minimum dwell time, an identification of an attribute, a different characteristic of a video segment, or a combination thereof. As shown by the video data 901, identifying an event in video segments may further narrow the video data to be processed during subsequent operations. Example aspects of identifying an event in video segments are illustrated and described in connection with FIG. 13.

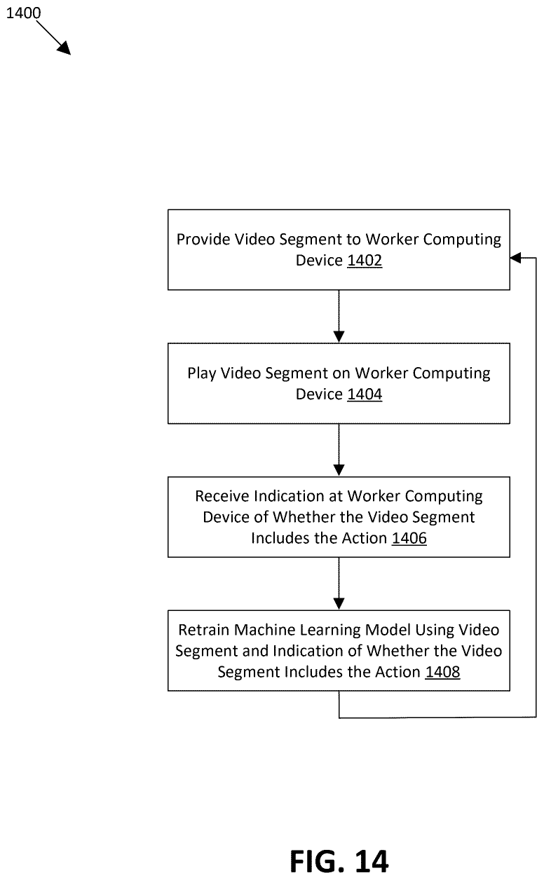

In the example shown, the action detection platform 104 may provide data to downstream system (step 918). For example, video segments with events may be provided to a worker device or to security personnel to review, as described further in connection with FIG. 14. Advantageously, by filtering the video data 901 in the manner shown in FIG. 9, the worker or security personnel may only have, for example, a manageable number of video segments to review, as opposed to all the data captured by the camera 116 at the operation 902. As such, the computer vision techniques of the action detection platform 104 may result in an improvement to an overall security infrastructure.

FIG. 10 is a flowchart of an example method 1000 for filtering video data. As described herein, one or more operations of the method 1000 may be used by the video processing platform 114 to perform aspects of the operation 906 of FIG. 9. However, the operation 906 of FIG. 9 and the method 1000 may include more or fewer operations than described in connection with FIG. 10.

In the example shown, the video processing platform 114 may detect a motion event in the video data received from the camera 116 (step 1002). In some embodiments, the video processing platform 114 may compare consecutive video frames to identify differences between video frames and detect motion events. In some embodiments, the video processing platform 114 may apply the object detector 208 to detect a motion event, as described in connection with FIG. 2.

In the example shown, the video processing platform 114 may detect a person in a video frame (1004). For example, the video processing platform 114 may apply the object detector 208 to detect a person in a video frame. For example, having detected a motion event, the video processing platform 114 may detect an object in the one or more video frames after a motion event is detected, and the video processing platform 114 may apply a machine learning model, which may classify the object as a person.

In the example shown, the video processing platform 114 may create a bounding box that includes the person (step 1006). For example, the video processing platform 114 may apply the object detector 208 to generate a bounding box in the one or more video frames that includes the person. For example, the video processing platform 114 may apply a machine learning model to generate a bounding box that includes the person, and the bounding box may be assigned an identifier.

In the example shown, the video processing platform 114 may track the bounding box to identify images of the person in the bounding box (step 1008). For example, the video processing platform 114 may apply the object tracker 210 to track the bounding box, and therefore the person, across a plurality of video frames. The video processing platform 114 may also determine a location of the person in each of the plurality of video frames.

In the example shown, the video processing platform 114 may determine a dwell time of the person (step 1010). For example, the video processing platform 114 may determine an amount of time that the person is present in the plurality of video frames that include the person. As another example, the video processing platform 114 may determine an amount of time that the person is present in a particular area of the plurality of video frames that include the person. In some embodiments, the video processing platform 114 may apply the dwell time tracker 214 described in connection with FIG. 2.

In the example shown, the video processing platform 114 may determine whether the dwell time is greater than a threshold (step 1012). The threshold may be an amount of time, such as 10 seconds, 30 seconds, 1 minute, 5 minutes, or another amount of time. In some embodiments, the threshold is set by a user of the dashboard 106 or by an administrator of the action detection platform 104. In some embodiments, the dwell time threshold is defined as part of a condition of an event. In response to determining that the dwell time is greater than or equal to the threshold, the video processing platform 114 may proceed to the step 1014 (e.g., taking the “YES” branch). In response to determining that the dwell time is less than the threshold, the video processing platform 114 may discard the video frames that include the person. By discarding these video frames, the video processing platform 114 may not include them in the subset of video data to be provided to the action detection platform 104. In the example shown, the video processing platform 114 may continue to obtain video data and may detect other motion events, thereby returning to the step 1002.

In the example shown, in response to determining that the dwell time is greater than a threshold, the video processing platform 114 may include the video frames in a subset of video data to be provided to the action detection platform (step 1014). In the example shown, the video processing platform 114 may continue to obtain video data and may detect other motion events, thereby returning to the step 1002.

FIG. 11 is a flowchart of an example method 1100. In some embodiments, the action detection platform 104 may apply operations of the method 1100 to perform aspects of the operations 914 and 916 of FIG. 9. However, the operations 914 and 916 of FIG. 9 and the method 1100 may include more or fewer operations than described in connection with FIG. 11. In some embodiments, operations of the method 1100 may be performed by the action detection subsystem 804 of the action detection platform 104.

In the example shown, the action detection platform 104 may apply a multi-modal machine learning model to generate a first embedding for a video segment (step 1102). For example, the action detection platform 104 may input a video segment or a plurality of video segments into the embedding generator 810 to generate a first embedding.

In the example shown, the action detection platform 104 may apply a multi-modal machine learning model to generate a second embedding for an action (step 1104). In some embodiments, the action detection platform 104 may apply the same machine learning model in step 1102 as step 1104, whereas in other embodiments, the action detection platform 104 may apply different machine learning models. In some embodiments, the action is associated with one or more of a text string describing the action, an image or images depicting the action, a video segment showing the action, a sound corresponding to the action, a structured data file, other data that may correspond to the action, or combination thereof. In some embodiments, the data corresponding to the action may be input by a user at the dashboard 106 and then subsequently input into the embedding generator 810. In some embodiments, such as when the action is a pre-defined action, the data corresponding to the action may be input by an engineer or administrator of the action detection platform 104. In some embodiments, to generate the embedding for the action, the action detection platform 104 may apply the embedding generator 810 to the data corresponding to the action.

In the example shown, the action detection platform 104 may determine a distance between the first embedding and the second embedding (step 1106). For example, the action detection platform 104 may determine a distance between the embeddings in a shared latent space to which the embedding are mapped by the embedding generator 810. Based on the distance, the action detection platform 104 may determine a similarity score for the embeddings (step 1108). In some embodiments, the shorter the distance between two embeddings, the higher the similarity score. Example aspects of the steps 1106-1108 are described in connection with the embedding comparison system 816 of FIG. 8.

In the example shown, the action detection platform 104 may determine whether the similarity score is greater than a threshold (step 1110). The threshold may be, for example, a user-defined value at the dashboard 106. In some embodiments, the threshold may be pre-defined by an administrator or engineer of the action detection platform. In response to determining that the similarity score is greater than or equal to the threshold (e.g., taking the “YES” branch), the action detection platform 104 may determine that the video segment includes the action (step 1112). In response to determining that the similarity score is less than the threshold (e.g., taking the “NO” branch), the action detection platform 104 may determine that the video segment does not include the action (step 1114).

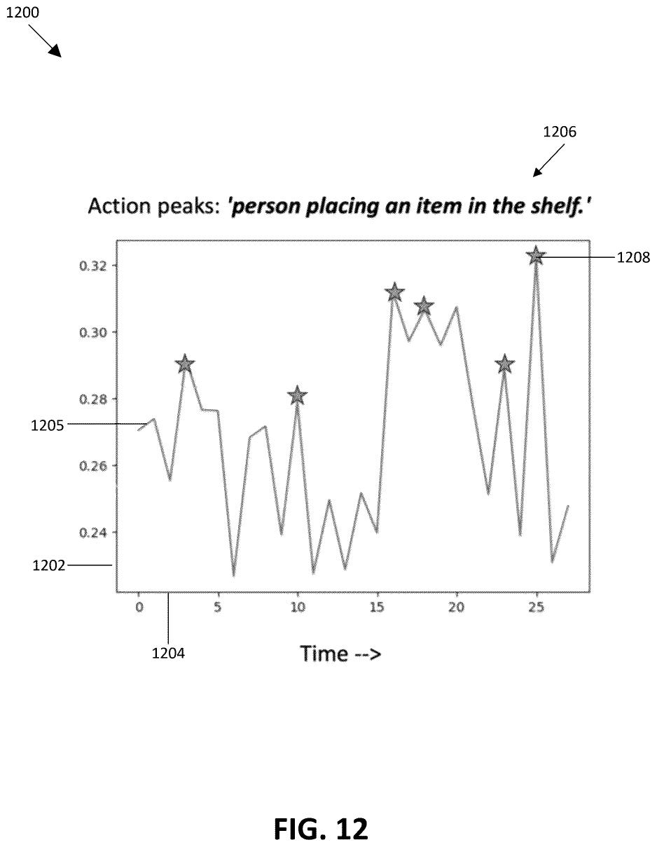

FIG. 12 illustrates an example diagram 1200 showing example aspects of detecting an action in video segments. FIG. 12 is only an example of one way to depict how actions are detected by the action detection platform 104. The y-axis 1202 of the diagram 1200 represents the degree of similarity scores between the action 1206 and video data. The x-axis 1204 represents a passage of time of video data. The x-axis 1204 may be measured in seconds. For example, x-axis 1204 may represent a passage of time for a single video segment or for a plurality of consecutive (or overlapping) video segments. Accordingly, the data 1205 represents similarity scores between the action 1206 and the video segment or video segments over time. The similarity scores may be determined, for example, according to operations described in connection with FIGS. 8-11.

As shown, the action 1206 corresponds to the text string “person placing an item in the shelf.” Each of the stars in the table, such as the star 1208 may signify a time during a video segment that the action 1206 is detected. For example, a threshold similarity score for detecting the action may be 0.28, and when a similarity score between the video segment and the action 1206 is greater than 0.28, it may be determined that the action 1206 occurs at that time in the video segment. As shown by six stars, six placing actions may have been detected in the video segment, which may be identified and tracked by the action counter 814. In some embodiments, even if a similarity score is greater than a threshold (e.g., at the time of 20 seconds, at which time the similarity score is around 0.31), it may be determined that the action did not occur at that time. For example, a user may have overridden a determination that an action occurred at that time, or the action detection platform 104 may have determined based on other characteristics of the video data that the action did not occur.

FIG. 13 is a flowchart of an example method 1300 that may be performed by the action detection platform 104. In some embodiments, operations of the method 1300 may be used to perform the operation 918 of FIG. 9. The method 1300 may include more or fewer operations than those described in connection with FIG. 13.

In the example shown, the action detection platform 104 may define an event (step 1302). In some embodiments, a user of the dashboard 106 may define an event in the action detection platform 104 to track certain activities that may take place at the locations 118. An event may include a plurality of conditions that may be detected based on a video segment or a group of video segments by the action detection platform 104, or based on other data that may be received by the action detection platform 104.

Conditions for events may be flexibly defined. For instance, an example event may be defined to be detected if a video or group of video segments includes a person that has a dwell time in an area of over 10 seconds, includes a person that performs five pick actions, includes a person that is wearing a mask and does not have a cart, and is captured between 8:00 AM 8:30 AM at Location X. Another example event may be defined for detecting when a common person has been reidentified at three different locations and that person has placed or picked a gift card at each location. Another example event could be a video segment in which a person performs an action, like picking or purchasing a particular item.

In some embodiments, the action detection platform 104 may define a plurality of events. Example conditions that may be defined for an event may include the following: a minimum dwell time; an identification or a characteristic of a key point, such as a movement of hand; a performance of an action, such as an action that may be detected by the action detection platform 104; a number of actions performed; an attribute of a person, such as the person's clothing; whether the person has been reidentified at a different location, as determined, for example, by the person reidentification platform 102; a time; a date; a location identifier or location identifiers; a camera identifier or camera identifiers; data received from a point-of-sales (POS) device; data received from a website; or other data that may be derived from a video segment or associated with a video segment.

In some embodiments, an event may be defined to depend on conditions that occur at systems other than the action detection platform 104 or the video processing platform 114. As such, the action detection platform 104 may be communicatively coupled with other systems that may provide data that is relevant to whether an event has occurred. For example, an event condition may be data at a point-of-sales (POS) device at a location 118. For instance, an example event may include two conditions: (1) that person picked a particular item; and (2) that the person did not purchase that item at the POS device. To determine whether this event has occurred, the action detection platform 104 may use data from the reidentification platform 102 and data generated at the POS device. In some embodiments, the action detection platform 104 may use data from an online system to detect events. For instance, as another example event, an event may include the following conditions: (1) a person purchases an item in a store; (2) the person requests a refund for the item via a website; and (3) the person requests a second refund at a second store. Another example event may be a person that picks a gift card and does not purchase that gift card, and then the gift card is placed back on a shelf and the number for that gift card is repeatedly entered into a website to determine whether funds have been added to the gift card, conditions that may be indicative of gift card tampering or fraud.

As such, advantageously, events can be flexibly defined to include various conditions that occur in different contexts of a multi-channel enterprise. Moreover, because the action detection platform 104 enables flexible definition of events, domain-specific human knowledge may be leveraged to identify combinations of conditions that are to be investigated further.

In the example shown, the action detection platform 104 may detect event signals (step 1304). Event signals may correspond to conditions that are associated with an event. Depending on the type of data, event signals may be generated by the action detection platform 104 or may be received by the action detection platform 104. In some embodiments, the event signals may be associated with a video segment or group of video segments that are being processed by the action detection platform 104 as part of determining whether an event is present. Example event signals that may be detected are a dwell time 1306, a key point characteristic 1308, a performance of an action 1310, an action count 1312, an attribute of a person 1314, a person reidentification, or another event, such as receiving certain data from a POS device or a website server.

In the example shown, the action detection platform 104 may aggregate event signals (step 1318). For example, as event signals are received, the action detection platform 104 may associate the event signals with a video segment or group of video segments. As another example, the action detection platform 104 may query databases that store data related to conditions associated with potential events to fetch event signals.

In the example shown, the action detection platform 104 may compare data corresponding to event signals to event conditions (step 1320). For example, based on the comparison, the action detection platform 104 may determine whether a video segment or a group of video segments satisfy event conditions. In some embodiments, if the action detection platform 104 determines that each condition for an event is met, then the action detection platform 104 may determine that an event is present in the one or more video segments.

In the example shown, the action detection platform 104 may push event data to event consumers (step 1322). Event data may include, for example, one or more video segments for which an event is identified. The event data may also include metadata associated with the one or more video segments. An event consumer may be an application or system that is configured to receive event data. In some embodiments, the action detection platform 104 automatically provides event data to one or more event consumers who are subscribed to receive event data upon detection of an event. Examples of event consumers may include, but are not limited to, the following: a worker device 1326, the dashboard 106, a video processing platform 114, a security system 1328, an event database 1330, or another application or system. The worker device 1326 may be a computing device of a worker at a location, such as a location at which the one or more video segments were captured for which the event is triggered. An example of providing event data to a worker device 1326 are further described in connection with FIG. 14. The security system 1328 may include a system that may review video segments for theft or fraudulent behavior. The event database 1330 may be a database that stores event data and that may be queried by other systems to later access and review the event data.

FIG. 14 is a flowchart of an example method 1400. In some embodiments, operations of the method 1400 may be performed after an action or an event have been detected by the action detection platform 104 for one or more video segments captured at a location. In the example of FIG. 14, a worker at the location may have a computing device that is communicatively coupled with one or more of the action detection platform 104 or the video processing platform 114. The computing device may be, for example, a smart phone, computer, tablet, or a specialized device for managing inventory. The method 1400 may have more or fewer operations that those described herein.

In the example shown, the action detection platform 104 may provide the one or more video segments to the worker device (step 1402). The action detection platform 104 may also provide metadata for the one or more video segments, or other data that may be associated with the one or more video segments, such as a description of an action that has been detected in the one or more video segments. In some embodiments, the action detection platform 104 may provide the one or more video segments to a video processing platform 114, which may provide the one or more video segments to the worker device. In other embodiments, the one or more video segments may be routed to the worker device in a different manner.

In the example shown, the worker may play the one or more video segments on the worker device (step 1404). As an example, the action detected by the action detection platform 104 in the one or more video segments may be a theft of an item in a particular location. By playing the one or more video segments, the worker may determine whether the video segments do, in fact, show the theft of the item. In some instances, the worker may, depending on the action in the one or more video segments, take corrective action. For example, if the one or more video segments show a gift card that was placed on a shelf by a customer, the worker may look at the gift card and remove it if it has been tampered with. As another example, the worker may send a communication with a security system or security team.

In the example shown, the worker computing device may receive an indication from the worker of whether the one or more video segments included the action (step 1406). For example, after watching the one or more video segments, the worker may input, into the worker device, whether the one or more video segments showed the action or did not show the action. For example, the action detection platform 104 may falsely detect an action indicative of theft in one or more video segments, and once the worker views the one or more video segments, the worker may determine that they do not show any action indicative of theft, an indication that the worker may input into the worker computing device. In some embodiments, the indication of whether the one or more video segment include the action may be provided to the action detection platform 104.

In the example shown, the action detection platform 104 may retrain a machine learning model using the one or more video segments and the indication received from the worker of whether the one or more video segments include the action (step 1408). For example, the action detection platform 104 may train the embedding generator 810. In some embodiments, if the worker determined that the one or more video segments include the action, then the one or more video segments and the action may be a positive sample when retraining the embedding generator 810, whereas if the worker determined that the one or more video segments did not include the action, the one or more video segments and the action may be a negative sample when retraining the embedding generator 810. In some embodiments, the action detection platform 104 may retrain only a select number of layers or weights of the embedding generator 810. In some embodiments, the action detection platform 104 may batch samples generated from a plurality of different worker devices and video segments to retrain the embedding generator 810.

FIG. 15-17 illustrate example user interfaces of the dashboard 106. Via the user interfaces shown in FIG. 15-17, a user may exchange data with one or more components of the data center 113, such as the person reidentification platform 102 or the action detection platform 104. The dashboard 106 may include more or fewer user interfaces than those illustrated in the examples of FIG. 15-17, and each of the user interfaced may include more or fewer components than described herein.

FIG. 15 illustrates an example user interface 1500 of the dashboard 106. The user interface 1500 includes example display fields and input fields that may enable a user to interact with the person reidentification platform 102. In the example shown, the user interface 1500 includes query data 1502, query metadata 1504, parameters 1506, a results region 1508, and a plurality of results, including the example result 1510.

The query data 1502 may include one or more images for which a reidentification task is to be performed. For example, the person reidentification platform 102 may attempt to match a person in one or more images of the query data 1502 with a person in one or more candidate images. As another example, the query data 1502 may be a video of a person for whom the reidentification task is to be performed. In some embodiments, the user may upload the query data 1502 or the user may select the query data 1502 within the dashboard 106. For example, the user may search for and select the query data in the dashboard 106. In some embodiments the person reidentification platform 102 may automatically select the query data 1502. The query metadata 1504 may include metadata of the query data 1502, such as a one or more of a location at which the query data 1502 was captured, a time or data at which the query data 1502 was captured, or an identifier of a camera that captured the query data.

The parameters 1506 may include one or more input fields for setting parameters that are to be used by the person reidentification platform 102 when performing a person reidentification task. In the example shown, the parameters 1506 include parameters that may define a set of candidate images against which the query data 1502 is compared. For example, the user may select, by directly selecting locations or by inputting one or more of a travel time or distance, images from which locations are to be included in a set of candidate images. Moreover, the user may select a date or time range for candidate images. In the example shown, the user may also select a threshold score, which may be a degree of similarity that is required for the person reidentification platform 102 to determine a match between images. Based in part of the selected parameters 1506, the query data 1502, and the query metadata 1504, the person reidentification platform 102 may determine whether one or more candidate images match the query data 1502.

The results region 1508 includes candidate images that the person reidentification platform 102 matched with the query data 1502. In the example shown, the person reidentification platform 102 identified three images, or sets of images, from a plurality of candidate images as including the same person as in the query data 1502. For each result, one or more images may be displayed by the user interface 1500. For example, the result 1510 may display one or more images captured at the Location D that depict a person identified by the person reidentification platform 102 as the same person in the query data 1502. In some embodiments, the user may select on one of the results to see details about the one or more matched images.

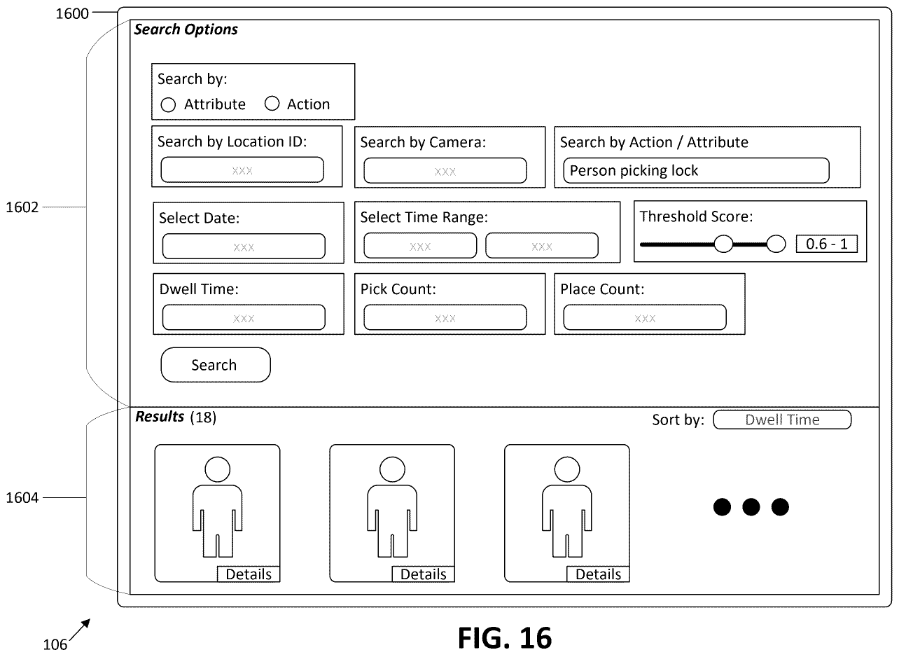

FIG. 16 illustrates an example user interface 1600 of the dashboard 106. The user interface 1600 includes example display fields and input fields that may enable a user to interact with the action detection platform 104. In the example shown, the user interface 1600 includes an input region 1602 and a results region 1604.

The input region 1602 includes a plurality of input fields corresponding to parameters that may be used by the action detection platform 104 as part of detecting actions or events. In the example shown, the input region includes input fields for the following: selecting whether to search for an attribute, an action, or both; selecting one or more locations for which video segments are to be searched; selecting one or more cameras associated with video segments to be searched; a text string corresponding to an action for which to search; a date of video segments to be searched; a time range of video segments to be searched; a minimum dwell time; a minimum pick count; and a minimum place count. In some embodiments, the pick and place actions are pre-defined actions. The inputs region also includes a field via which a user may set a threshold. In some embodiments, if the threshold is higher, then the action detection platform 104 may require a greater degree of similarity between a video segment and an action in order to determine that the video segment includes the action. In some embodiments, input fields of the input region 1602 may also be used to define conditions for an event.

The results region 1604 includes video segments that the action detection platform 104 identified as meeting the parameters input via the input region 1602. In some embodiments, a user may play the results in the dashboard 106. In some embodiments, a user may select a result to view more details corresponding to the result. In some embodiments, a user may select one of the results and perform a reidentification task using the person reidentification platform 102 for a person shown in the video segment of the selected result.

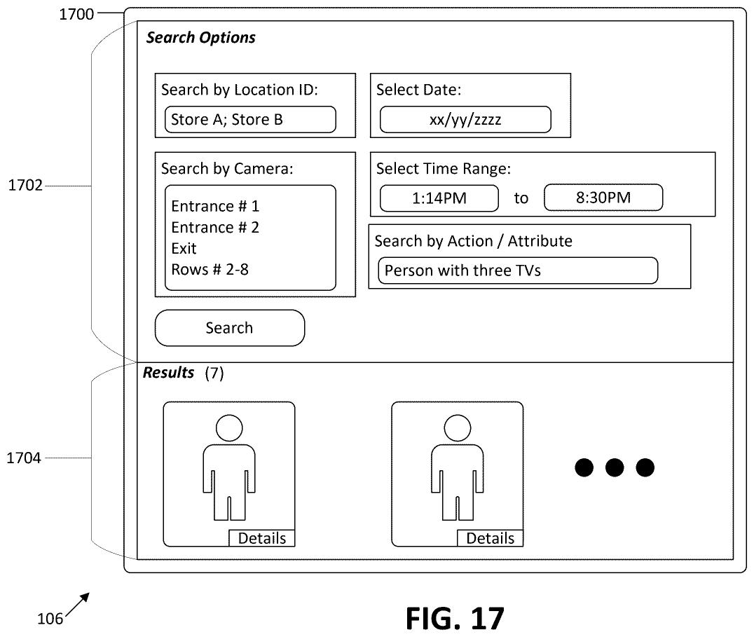

FIG. 17 illustrates an example user interface 1700 of the dashboard 106. The user interface 1700 may be an additional or an alternative user interface for interacting with action detection platform 104. Similar to the user interface 1600, the user interface 1700 includes an input region 1702 and a results region 1704. Based at least in part on the parameters received via the input region 1702, the action detection platform 104 may identify one or more video segments that include the input action and that meet other input parameters. The action detection platform 104 may output results in the results region 1704.

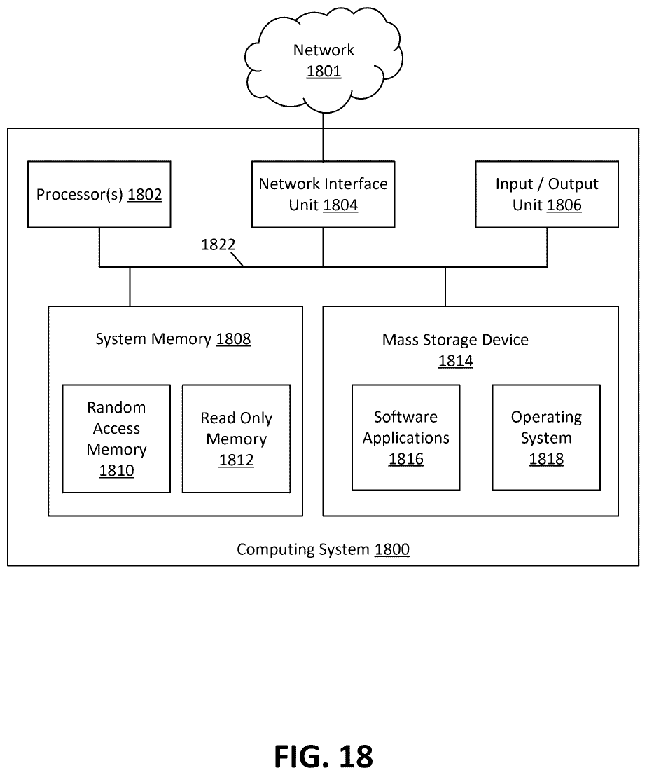

FIG. 18 illustrates an example block diagram of a virtual or physical computing system 1800. One or more aspects of the computing system 1800 can be used to implement the system and processes described herein.

In the embodiment shown, the computing system 1800 includes one or more processors 1802, a system memory 1808, and a system bus 1822 that couples the system memory 1808 to the one or more processors 1802. The system memory 1808 includes RAM (Random Access Memory) 1810 and ROM (Read-Only Memory) 1812. A basic input/output system that contains the basic routines that help to transfer information between elements within the computing system 1800, such as during startup, is stored in the ROM 1812. The computing system 1800 further includes a mass storage device 1814. The mass storage device 1814 is able to store software instructions and data. The one or more processors 1802 can be one or more central processing units or other processors.

The mass storage device 1814 is connected to the one or more processors 1802 through a mass storage controller (not shown) connected to the system bus 1822. The mass storage device 1814 and its associated computer-readable data storage media provide non-volatile, non-transitory storage for the computing system 1800. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1800.

According to various embodiments of the invention, the computing system 1800 may operate in a networked environment using logical connections to remote network devices through the network 1801. The network 1801 is a computer network, such as an enterprise intranet and/or the Internet. The network 1801 can include a LAN, a Wide Area Network (WAN), the internet, wireless transmission mediums, wired transmission mediums, other networks, and combinations thereof. The computing system 1800 may connect to the network 1801 through a network interface unit 1804 connected to the system bus 1822. It should be appreciated that the network interface unit 1804 may also be utilized to connect to other types of networks and remote computing systems. The computing system 1800 also includes an input/output controller 1806 for receiving and processing input from a number of other devices, including a touch user interface display screen, or another type of input device. Similarly, the input/output controller 1806 may provide output to a touch user interface display screen or other type of output device.

As mentioned briefly above, the mass storage device 1814 and the RAM 1810 of the computing system 1800 can store software instructions and data. The software instructions include an operating system 1818 suitable for controlling the operation of the computing system 1800. The mass storage device 1814 and/or the RAM 1810 also store software instructions, that when executed by the one or more processors 1802, cause one or more of the systems, devices, or components described herein to provide functionality described herein. For example, the mass storage device 1814 and/or the RAM 1810 can store software instructions that, when executed by the one or more processors 1802, cause the computing system 1800 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the components and operations shown and described above.

This disclosure described some aspects of the present technology with reference to the accompanying drawings, in which only some of the possible aspects were shown. Other aspects can, however, be embodied in different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, operations can be repeated, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A system for detecting actions in video, the system comprising:
a video processing platform including a first at least one processor and a first memory storing first instructions; and
an action detection platform communicatively coupled with the video processing platform, the action detection platform including a second at least one processor and a second memory storing second instructions;
wherein the first instructions, when executed by the first at least one processor, cause the video processing platform to:
obtain video data captured by a camera at a location;
filter the video data to a subset of the video data; and
provide the subset of the video data to the action detection platform;
wherein the second instructions, when executed by the second at least one processor, cause the action detection platform to:
receive the subset of the video data;
chunk the subset of the video data into a plurality of video segments;
apply a multi-modal machine learning model to the plurality of video segments to generate a plurality of embeddings for the plurality of video segments;
perform a comparison of a first embedding of the plurality of embeddings for the plurality of video segments and a second embedding corresponding to an action; and
based on the comparison, determine that a video segment corresponding to the first embedding includes the action.

2. The system of claim 1, wherein the second instructions, when executed by the second at least one processor, cause the action detection platform to:
receive a text string describing the action; and
apply the multi-modal machine learning model to the text string to generate the second embedding corresponding to the action, wherein the second embedding corresponding to the action and the plurality of embeddings for the plurality of video segments are in a shared latent space;
wherein performing the comparison of the first embedding and the second embedding comprises:
determining a distance in the shared latent space between the first embedding and the second embedding;
based on the distance, determining a similarity score for the first embedding and the second embedding; and
determining whether the similarity score is greater than a threshold.

3. The system of claim 1, wherein filtering the video data to the subset of the video data comprises repeatedly performing:
detecting a motion event in the video data;
after detecting the motion event, detecting a person in a video frame of the video data;
creating a bounding box to include the person;
perform a tracking of the bounding box across a plurality of video frames of the video data;
based on the tracking, determine a dwell time of the person at the location;
determine whether the dwell time is greater than a threshold dwell time;
in response to determining that the dwell time is greater than the threshold dwell time, including the plurality of video frames in the subset of the video data.

4. The system of claim 3,
wherein the first instructions, when executed by the first at least one processor, cause the video processing platform to:
identify a key point of the person in the plurality of video frames; and
determine a movement of the key point in the plurality of video frames;
wherein determining that the video segment corresponding to the first embedding includes the action is further based at least in part on the movement of the key point in the plurality of video frames;
wherein the key point corresponds to a hand of the person.

5. The system of claim 1, wherein the action is a pick of an item from a shelf or a place of the item on the shelf.

6. The system of claim 5, wherein the item is a gift card.

7. The system of claim 1,
wherein the location is a retail store;
wherein the video processing platform is located on premises at the retail store; and
wherein the action detection platform is located remote from the retail store.

8. The system of claim 1, wherein the second instructions, when executed by the second at least one processor, cause the action detection platform to provide the video segment corresponding to the first embedding to a computing device of a worker at the location.

9. The system of claim 8, wherein the second instructions, when executed by the second at least one processor, cause the action detection platform to:
receive, from the computing device of the worker at the location, an indication of whether the video segment includes the action; and
retrain the multi-modal machine learning using the video segment and the indication of whether the video segment includes the action.

10. The system of claim 1, wherein the second instructions, when executed by the second at least one processor, cause the action detection platform to:
from the video segment, select a video frame that includes a person;
using a person reidentification platform, identify an image of the person captured by a second camera at a second location, the second camera being different from the camera and the second location being different from the location.

11. The system of claim 1, wherein the second instructions, when executed by the second at least one processor, cause the action detection platform to:
define event conditions; and
determine that the video segment satisfies the event conditions;
wherein the event conditions include the action and a minimum dwell time at the location.

12. The system of claim 1, wherein the second instructions, when executed by the second at least one processor, cause the action detection platform to:
perform comparisons of the plurality of embeddings for the plurality of video segments and the second embedding corresponding to the action;
based on the comparisons, identify a set of video segments of the plurality of video segments of the plurality of segments that include the action; and
determine an action count corresponding to the action based on a size of the set of video segments.

13. The system of claim 1,
further comprising a dashboard communicatively coupled with the action detection platform;
wherein the dashboard is configured to:
receive a text string describing the action; and
play the video segment.

14. The system of claim 1,
further comprising a dashboard communicatively coupled with the action detection platform;
wherein the dashboard is configured to:
receive a selection of the location; and
receive a selection of a date and a time range;
wherein the video segment occurs on the date and during the time range.

15. A method for detecting actions in video, the method comprising:
obtaining, at a video processing platform, video data captured by a camera at a location;
filtering, at the video processing platform, the video data to a subset of the video data;
providing, from the video processing platform, the subset of the video data to an action detection platform;
receiving, at the action detection platform, the subset of the video data;
chunking, at the action detection platform, the subset of the video data into a plurality of video segments;
applying a multi-modal machine learning model to the plurality of video segments to generate a plurality of embeddings for the plurality of video segments;
performing, at the action detection platform, a comparison of a first embedding of the plurality of embeddings for the plurality of video segments and a second embedding corresponding to an action; and
based on the comparison, determining, at the action detection platform, that a video segment corresponding to the first embedding includes the action.

16. The method of claim 15, further comprising:
defining an event to be triggered in response to determining that a video segment includes the action and in response to receiving data from a point-of-sales device at the location;
receiving the data from the point-of-sales device at the location; and
in response to determining that the video segment corresponding to the first embedding includes the action and in response to receiving the data from the point-of-sales device, detecting the event.

17. The method of claim 16,
wherein the action is a pick of an item; and
wherein the data from the point-of-sales device is purchase data that does not include the item.

18. The method of claim 15,
wherein the location is a retail store;
wherein the video processing platform is located on premises at the retail store; and
wherein the action detection platform is located remote from the retail store.

19. An action detection platform comprising:
at least one processor; and
memory storing instructions, wherein the instructions, when executed by the at least one processor, cause the action detection platform to:
receive, from a video processing platform, a subset of video data, the subset of video data being filtered from video data captured by a camera at a location;
chunk the subset of the video data into a plurality of video segments;
apply a multi-modal machine learning model to the plurality of video segments to generate a plurality of embeddings for the plurality of video segments;
perform a comparison of a first embedding of the plurality of embeddings for the plurality of video segments and a second embedding corresponding to an action; and
based on the comparison, determine that a video segment corresponding to the first embedding includes the action.

20. The action detection platform of claim 19, wherein the instructions, when executed by the at least one processor, cause the action detection platform to:
receive, via a dashboard, a text string from a user, the text string corresponding to the action; and
applying the multi-modal machine learning model to the text string to generate the second embedding corresponding to the action.
